(19) United States
(12) Patent Application Publication
(10) Pub. No.: US 2010/0089529 A1
(43) Pub. Date: Apr. 15, 2010

(54) MICROFLUIDIC DEVICES AND PRODUCTION METHODS THEREFOR

(75) Inventors: Claus Barholm-Hansen, Vaerlose (DK); Jacques Jonsmann, Gorlose (DK); Thomas Rosleff Baekmark, Copenhagen (DK); Bent Overby, Glostrup (DK); Christian Berendsen, Soborg (DK); Salim Bouaidat, Copenhagen (DK); Niels Kristian Bau-Madsen, Hellerup (DK)

Correspondence Address: BUCHANAN, INGERSOLL & ROONEY PC, POST OFFICE BOX 1404, ALEXANDRIA, VA, 22313-1404, US

(73) Assignee: Inverness Medical Switzerland GmbH, Zug (CH)

(21) Appl. No.: 11/813,835

(22) PCT Filed: Jan. 11, 2006
(86) PCT No.: PCT/DK06/50002

§ 371 Date: Dec. 23, 2009

Related U.S. Application Data
(60) Provisional application No. 60/642,987, filed on Jan. 12, 2005.
(60) Provisional application No. 60/684,158, filed on May 25, 2005.

(30) Foreign Application Priority Data
Jan. 12, 2005 (DK) PA 2005 00057
May 19, 2005 (DK) PA 2005 00732

(51) Int. Cl. B32B 38/10

(52) U.S. Cl. 156/247

(57) ABSTRACT

A method of producing a microfluidic device having at least one flow path may include providing a base substrate with a first surface and a top substrate with a second surface, hydrophilically treating at least one of the first and the second surfaces to provide a surface layer with a higher surface tension than the surface tension prior to the hydrophilic treatment, partly or totally removing the surface layer with a higher surface tension in a selected pattern of the hydrophilically treated first and/or second surfaces, to thereby provide the selected pattern with a lower surface tension than prior to the partly or totally removal of the surface layer with a higher surface tension in said selected pattern of the hydrophilic treated first and/or second surfaces, and joining said base substrate and top substrate to each other to provide a flow path between said first and second surfaces.

### TECHNICAL FIELD

The invention relates to a method of producing a microfluidic device comprising at least one flow path, as well as microfluidic devices optionally produced by said method.

### BACKGROUND ART

Microfluidic devices comprising one or more flow paths e.g. in the form of flow channels are well known in the art. Such devices normally depend totally or partly on capillary forces to fill the flow patch. The geometry of the channels is therefore very important. In certain microfluidic devices additional forces may be applied to fill the flow patch, e.g. centrifugal forces, pumping forces and other.

U.S. Pat. No. 6,451,264 discloses a microfluidic device comprising a capillary pathway, wherein a plurality of groups of microstructures are fixed in the capillary pathway. The groups of microstructures are in the form of discrete segments protruding from one of the major walls of the pathway and into the pathway. These discrete segments are arranged to facilitating a desired transport along the pathway. The microfluidic device is produced by joining to or more pieces which itself is produced by micro-injection molding processes.

US 2004/0206399 discloses a microfluidic device with a microchannel provided by a first and a second surface. The microfluidic device described therein may comprise hydrophilic surfaces and/or hydrophobic surfaces to help guide substances out of an outlet to provide the substances to a mass spectrometer. It is also described that hydrophobic surfaces may prevent fluidic substances from undesired spreading. The microfluidic device disclosed herein is produced by adjoining two substrates to each other to provide a microchannel there between. The surfaces of the substrate may be coated with a coating to thereby provide the desired hydrophilic character. US 2004/0265172 discloses another microfluidic device, which is particularly for use in analysis of biological samples. This microfluidic device comprises a channel with an inlet port, wherein the channel comprises a vent passageway for removing air displaced by a liquid sample as it enters through the inlet port. Thereby the air can be purged out of the channel as the liquid sample enters the channel and formation of air bubbles can be avoided. The channel may comprise a flow restriction to allow the air to escape without the liquid sample escaping the same way. This flow restriction may e.g. be in the form of a groove or weir. The microfluidic device may comprise a hydrophilic capillary passageway with a hydrophobic capillary stop in the form of a smaller passageway having hydrophobic walls. The hydrophobic/hydrophobic character of the walls may be adjusted by coating with a hydrophobic/hydrophilic material, corona treatment or grafting.

The above disclosed prior art microfluidic devices fulfill many of the needs to such equipments. However, it may be difficult to produce microstructured elements, such as discrete segments in a microfluidic device, and also the mold for injection molding may be expensive. In case a specific microfluidic device should be modified, a new mold will be necessary.

Also it is difficult to modify the hydrophilic and hydrophobic character of a limited part of a surface, e.g. to provide a hydrophobic stop.

### SUMMARY OF INVENTION

The objective of the present invention is thus to provide a novel method of producing a microfluidic device, which method overcomes the drawbacks mentioned above.

In particular the objective of the invention is to provide a method of producing a microfluidic device, which method is simple and economically beneficial and by use of which high quality microfluidic devices can be produced.

These and other objectives have been achieved by the invention as it is defined in the claims.

The inventors of the present invention have thus developed a completely new method of producing a microfluidic device with a flow path wherein said flow path comprises at least one hydrophobic surface section and at least one hydrophilic surface section.

Microfluidic devices produced by use of this method can be produced with high quality, high precision and high reproducibility. Furthermore it is very simple and inexpensive to modify the microfluidic device.

The method of the invention has shown to have several benefits which will be further described below.

Also the method of the invention offers the possibility of producing microfluidic device with microstructured surface pattern, which has not hitherto been possible. The present invention also relates to such microfluidic devices as well as other microfluidic device as defined in the claims.

In the following the terms hydrophilic and hydrophobic are used as relative terms unless other is specified, i.e. a flow path with at least one hydrophobic surface section and at least one hydrophilic surface section means at least one hydrophobic surface section which is more hydrophobic than the hydrophilic surface section and at least one hydrophilic surface section which is more hydrophilic than the hydrophobic surface section.

The term “flow path” is a pathway arranged in the microfluidic device along which path a liquid sample can flow either by means of capillary forces or by means of a combination of capillary forced and external forces e.g. centrifugal forces, pumping forces, vacuum and similar forces which may pull the sample along the flow path.

In most microfluidic devices the flow path may preferably be in the form of a closed flow path in the form of a channel where the liquid is completely confined by walls except for inlet, outlet and vents. The flow path may thus be open along a part or all of its edge, and/or it may comprise a flow path section which is free of a lid. These embodiments are disclosed below.

The term “borderline(s)” is the line along the flow path e.g. defined by a physical edge, defined by a hydrophobic surface character or defined by other means which prevents the flow of a liquid sample from flowing beyond said borderlines.

The method of producing a microfluidic device having at least one flow path according to the invention comprises the steps of
i. providing a base substrate with a first surface and a top substrate with a second surface,
ii. hydrophilically treating at least one of the first and the second surfaces to provide a surface layer with a higher surface tension than the surface tension prior to the hydrophilic treatment,
iii. partly or totally removing the surface layer with a higher surface tension in a selected pattern (also referred to as desired pattern or just pattern) of the hydrophilically treated first and/or second surfaces, to thereby provide the selected pattern with a lower surface tension than prior to the partly or totally removal of the surface layer with a higher surface tension in said selected pattern of the hydrophilically treated first and/or second surfaces, and
iv. joining said base substrate and top substrate to each other to provide a flow path between said first and second surfaces.

The respective base substrate and top substrate may be produced in subsections, but in general it is simpler to produce the base substrate in one piece and the top substrate in one piece.

Methods of producing such base and top substrates are well known in the art, and in general all methods of producing these parts may be implemented in the present invention.

The base and top substrates may thus be shaped by any method e.g. using casting, pressing, cutting and moulding. In general it is preferred using injection moulding, in particular when the flow path is to be a flow channel. In one embodiment both of the base and top substrates are produced using injection-moulding, in another embodiment the base substrate is produced using injection moulding and the top substrate is a simple plate e.g. produced by pressing.

As it will be understood by the skilled person a plurality of different microfluidic devices can be produced from one type of molded base and top substrates using the method of the present invention, simply by varying the selected pattern.

The base and top substrates may in principle be of any kind of materials such as it is general known in the art. The materials for the base and top substrates may be selected independently of each other; provided that the materials can be joined e.g. by adding additional joining layers. Preferred materials include the materials selected from the group consisting of glass, ceramics, metals, silicon and polymers e.g. plastics, preferably said base and said lid substrates being made from a polymer, more preferably an injection mouldable polymer, such as a polymer selected from the group consisting of acrylonitrile-butadiene-styrene copolymer, polycarbonate, polydimethylsiloxane (PDMS), polyethylene, polymethylmethacrylate (PMMA), polymethylpentene, polypropylene, polystyrene, polysulfone, polytetrafluoroethylene (PTFE), polyurethane, polyvinylchloride (PVC), polyvinylidine fluoride, nylon, styrene-acryl copolymers and mixtures thereof.

In certain embodiments, additives, such as carbon black, dyes, titanium dioxide, gold, e.g. electroplated gold or electrolessly plated gold, carbon particles, additional polymers, e.g. a secondary polymer or second phase polymer reactive with the primary polymer of the laminate layer, IR absorbing materials, and the like, may be included, as a surface coating and/or a body filler, in the materials used to form any of the layers of a multi-layer laminated cartridge base and lid. A layer formed of materials suitable for micromachining may be used, for example, with another layer formed of material compatible with waveguide, thick film, thin film or other surface treatments. Given the benefit of this disclosure, it will be within the ability of those skilled in the art to select materials for the cartridge base and lid suited for the particular application.

Preferably the material used for forming at least the base substrate but preferably also the top substrate is a material which can be shaped by injection molding. Such material is normally also relatively simple to bond to other materials e.g. by welding.

The base substrate and the top substrate may be bonded using any bonding method. Preferred bonding methods include the bonding methods selected from the group consisting of adhesives, mechanical sealing, solvent assisted joining, gluing and welding, such as ultrasonic welding, impulse welding, laser mask welding and heat welding.

When performing the bonding e.g. by gluing or welding, the base substrate and the top substrate are pressed against each other. For controlling the bonding step to provide a desired thickness of the bonding material and/or the interface between the base substrate and the top substrate, adjacent to and along with the flow path, a bonding stop unit in the form of a solid projection from the base substrate and/or the top substrate e.g. in an area where no bonding should be provided, may be used to control the distance.

The step of joining said base substrate and top substrate to each other to provide a flow path between said first and second surfaces may preferably be performed so that the distance between said first and second surfaces along at least one flow path is of capillary dimension, preferably in the range 1 μm-1000 μm, such as 25 μm-250 μm, such as 50 μm-100 μm.

In one embodiment of the invention the base substrate and the top substrate are shaped so that when they are joined to each other a cavity is formed, with a distance between the first and the second surface of between 1 μm 1000 μm, such as 25 μm-250 μm, such as 50 μm-100 μm. The cavity may in one embodiment be broader than the flow path, in which case the flow path is provided by arranging at least one or both of the first and second surfaces with one or two hydrophobic border lines along the flow path, the hydrophobic border line being more hydrophobic than the flow path. In this embodiment the flow path is an open flow path with no physical edges, but the edges are provided by the one or more hydrophobic border lines along the flow path. In this embodiment it is desired that the hydrophobic border line(s) has a surface tension of less than 60 mN/m, more preferably less than 30 or even less than 15 mN/m.

In one embodiment of the invention the base substrate (also called a base cartridge) comprises a base cavity e.g. comprising one or more channels The first surface preferably comprises the surface of the base cavity and the hydrophilic treatment includes hydrophilic treatment of at least a part e.g. all of said first surface of the base cavity.

This base cavity may preferably be arranged so that when the base substrate and the top substrate are joined to each other a cavity is formed which may be closed to form a physical edge along at least a part of the edge of the flow path, and/or the flow path may be defined partly or totally by one or more hydrophobic border lines as disclosed above.

In one embodiment the base cavity is shaped to form a closed flow path in the form of a flow channel where the liquid is completely confined by walls except for inlet, outlet and vents. The flow channel preferably has a bottom and edges formed by the first surface and a lid formed by the second surface.

The base cavity may have any shape, including at least one channel. Such cavity shape is generally known in the art and may preferably include one or more chambers in fluid connection with at least one channel and optionally with one or more other chambers to provide a flow path along said channel(s) and chambers along said fluid connection(s).

In one embodiment the cavity is shaped to provide the microfluidic device with one or more chambers in the form of channel sections having more than 50% larger cross sectional area in a sectional cut perpendicular to the centre direction of the flow channel, said chambers may e.g. be arranged to be used as reservoir chambers, mixing chambers, reaction chambers, incubation chambers, and termination chambers.

Such chambers may have any size and shape as it is well known in the art e.g. as disclosed in U.S. Pat. No. 5,300,779 and U.S. Pat. No. 5,144,139.

Desired dimensions and shapes of channels and chambers may be as disclosed in our co pending applications Nos PA 2004 01913 DK corresponding to U.S. provisional Ser. No. 60/634,289 and PA 2005 00057 DK corresponding to U.S. provisional Ser. No. 60/642,987 which are hereby incorporated by reference.

In one embodiment the channel may thus preferably have a width of at least 5 μm, such as between 10 μm, and 20 mm, such as between 20 μm and 10 mm, and the depth of the channel may preferably be at least 0.5 μm, such as between 1 μm and 1 mm, such as between 5 μm and 400 μm, such as 25 μm and 200 μm.

The said base cavity may comprise one or more edge portions with edge surfaces, which comprise structural edge microstructures, e.g. in the form of one or more of the structural shapes gaps, protrusions, and depressions, wherein the edge microstructures preferably are of substantially smaller dimension than the cavity of the base cartridge. Preferably the structural edge microstructures may be as disclosed in any one of our co pending applications Nos PA 2004 01913 DK corresponding to US provisional serial No. 60/634,289 and PA 2005 00057 DK corresponding to U.S. provisional Ser. No. 60/642,987 incorporated by references.

The microfluidic device of the invention may thus in one embodiment comprise a cartridge base with a flow channel and a lid for the flow channel. The micro fluidic device further comprises at least one groove formed along the flow channel and a ridge separating said flow channel from the groove. The ridge is protruding from a first one of the cartridge base and the lid towards the second one of the cartridge base and the lid, wherein the ridge in at least a part of its length is not fixed to the second one of the cartridge base and the lid.

The microfluidic device of the invention may further in the same or in another embodiment comprise a flow channel with an interface between a cartridge base and a lid. The cartridge base comprises a channel shaped depression and the lid is bonded to said cartridge base to form the flow channel. The interface between the cartridge base and the lid, adjacent to and along with the flow channel, comprises at least two capillary gap sections in the form of a gap between the lid and the cartridge base, separated by a flow break section, which flow break section provides a barrier for a capillary flow of liquid along adjoining capillary gap sections.

Generally it is preferred that at least the base substrate is subjected to the hydrophilic treatment. It has thus been found that in case the second surface of the top substrate (also called the lid) has a surface tension which is not too low e.g. above 20 mN/m, preferably above 30 mN/m, more preferably above 40 mN/m, the second surface of the top substrate need not be subjected to a hydrophilic treatment.

In one embodiment both the first and the second surfaces are at least partly subjected to a hydrophilic treatment.

Prior to the hydrophilic treatment the surface to be treated may in principle have any surface tension. Often the surface tension will be defined by the bulk material of the base substrate/top substrate. However, the surface to be treated may be coated with another coating prior to the hydrophilic treatment.

Table 1 shows examples of surface energy for a number of materials (solids and liquids) in air, at 20° C. As it can be seen, the surface energy of water is around 73 mN/m. Aqueous solutions generally are around 60-77 mN/m, and for many aqueous solutions the surface energy is fairly close to the surface energy of pure water.

TABLE 1

| Surface | surface energy (mN/m) |
|---|---|
| Acetic Acid | 28 |
| Acetone | 24 |
| Benzene | 29 |
| Carbon Tetrachloride | 27 |
| Ethyl Alcohol | 24 |
| Ether | 17 |
| Glycerol | 63 |
| Hexane | 18 |
| Isopropyl Alcohol | 22 |
| Toluene | 29 |
| Water | 73 |
| NaCl in Water (Salt Solution) | 73 |
| 1.2% MgSO₄ in Water | 73 |
| (Magnesium Sulfate) | |
| 5.7% NaOH in Water (Sodium Hydroxide) | 76 |
| 4.1% H₂SO₄ in Water (Sulfuric Acid) | 72 |
| 5% Acetic Acid (Vinegar) | 60 |
| 10% Sucrose in Water (Sugar Solution) | 73 |
| 10% Methyl Alcohol in Water | 59 |
| 5% Acetone in Water | 56 |
| Mercury | 435 |
| Polytetrafluoroethylene (Teflon*) | 18 |
| Polyvinylidene Fluoride | 25 |
| Polypropylene | 29 |
| Polyethylene | 31 |
| Polystyrene | 33 |
| Amylopectin | 35 |
| Polyepichlorohydrin | 35 |
| Amylose | 37 |
| Poly Vinyl Alcohol | 37 |
| Poly Vinyl Chloride | 39 |
| Starch | 39 |
| Polysulfone | 41 |
| Polycarbonate | 42 |
| Polyethylene Terephtholate (Polyester) | 43 |
| Casein (Milk Protein) | 43 |
| Polyacrylonitrile | 44 |
| Cellulose | 44 |
| Poly Hexamethylene Adipomide (Nylon 6/6) | 46 |

The surface energy (also called free surface energy) is a specification of the amount of energy that is associated with forming a unit of surface at the interface between two phases. A surface will be absolutely hydrophilic i.e. having a contact angle towards water of less than 90 degree when the solid-water surface energy exceeds that of the solid-vapour interface. The bigger the difference is, the more hydrophilic the system is. In the same manner a surface can be said to be absolutely liquid-philic (liquid loving) for a certain liquid when the solid-liquid surface energy exceeds that of the solid-vapour interface. The bigger the difference is, the more liquid-philic the system is.

The surface energy and the surface tension are two terms covering the same property of a surface and in general these terms are used interchangeably. The surface energy of a surface or surface section may be measured using a tensiometer, such as a SVT 20, Spinning drop video tensiometer marketed by DataPhysics Instruments GmbH. In this application the terms “surface energy” and “surface tension” designate the macroscopic surface energy, i.e. it is directly proportional to the hydrophilic character of a surface measured by contact angle to water as disclosed below. In comparing measurements, e.g. when measuring which of two surface parts has the highest surface energy, it is not necessary to know the exact surface energy and it may be sufficient to simply compare which of the two surfaces has the lower contact angle to water.

In order to establish a capillary flow of a specific liquid in a flow channel, at least some of the surface of the flow channel wall needs to have a surface energy which can drive the liquid forward. According to a well known theory, which however should not be interpreted so as to limit the scope of the invention, a capillary flow can only be established if at least some of the surface of the flow channel wall has a contact angle to the liquid in question which is less than 90°. In principle the lower the angle is, the faster the flow will be. In this connection it can also be mentioned that the surrounding air may also influence the contact angle between the liquid and the flow channel wall according to Youngs equation which links the contact angle, the liquid-vapour surface tension of the drop, and the surface tension of solid in contact with liquid.

Contact angle measurement is used as an objective and simple method to measure the comparative surface tensions of solids. The Young equation states that the surface tension of a solid is directly proportional to the contact angle. The equation is:

g(sv)=g(lv)(cos q)+g(sl)

where g(sv) is the solid-vapour interfacial surface tension, g(lv) is the interfacial surface tension of the liquid-vapour interface, g(sl) is the interfacial surface tension between solid and liquid, and (q) is the contact angle.

Also it is known that the roughness of a surface may have a large influence on the hydrophilic character of a surface. In general it can be said that within a unit area of a rough surface, the intensity of the surface energy is greater than in the corresponding area on a smooth surface of the same material. By changing the roughness of a surface section the hydrophilic character can be changed accordingly. Without being bound by this theory, it should be mentioned that according to Wenzels theory a surface with a contact angle to a liquid which is less than 90° will obtain a reduced contact angle to said liquid when roughening the surface, and a surface with a contact angle to a liquid which is higher than 90° will obtain an increased contact angle to said liquid when roughening the surface. Further information about this effect can be found in “Surface Topology and Chemical Parameters Controlling Superhydrophobicity Studied by Contact Angle Measurements” by N. E. Schlotter, published by internet and enclosed as an appendix.

In one embodiment the surface to be subjected to hydrophilic treatment (at least a part of one of the first and the second surfaces) has a surface tension prior to the hydrophilic treatment which is less than 80, preferably less than 73, such as less than 60, such as between 20 and 50 mN/m, preferably at least one of the first and the second surfaces of the substrates which is subjected to the hydrophilic treatment has an initial surface tension prior to the hydrophilic treatment which is less than 80, preferably less than 73, such as less than 60, such as between 20 and 50 mN/m.

In case the surface to be subjected to hydrophilic treatment previously has been coated with a hydrophobic coating as disclosed later in the description, this surface may have an even lower surface tension e.g. below 20 mN/m.

In general it is desired that the hydrophilic treatment provides at least one of the first and the second surfaces with a surface tension of more than 60, preferably of more than 70 mN/m, more preferably of more than 85 mN/m.

As mentioned above it is desired that the hydrophilically treated surface area has a surface tension which is at least as high as the surface tension of the liquid sample adapted to be used with the microfluidic device.

In one embodiment the hydrophilic treatment provides at least one of the first and the second surfaces with a surface tension which is increased with at least 5 mN/m, such as at least 10 mN/m, such as at least 15 mN/m, such as at least 20 mN/m, compared to its initial surface tension prior to the hydrophilic treatment. As mentioned above the roughness may also influence the hydrophobic/hydrophilic character of the surface. This means that after the step of removing surface layer, the pattern will have surface tension difference between the surface tension of the selected pattern and the surface adjacent to the selected pattern which is up to e.g. 10 mN/m more than the surface tension increase provided by the hydrophilic treatment.

It is preferred that the step of partly or totally removing the surface layer with a higher surface tension in a selected pattern of the hydrophilically treated first and/or second surfaces provides the pattern with a surface tension which is decreased with at least 3 mN/m, such as at least 5 mN/m, such as at least 10 mN/m, such as at least 15 mN/m, such as at least 20 mN/m, compared to surface tension prior to the step of partly or totally removing the surface layer.

By selecting the surface energies of the surface to be treated and optionally the surface energies of initially applied layers of said surface as well as the surface energy generated by the hydrophilic treatment and furthermore the thickness, part of the surface layer removed during the step of removing, the selected pattern and the surface adjacent to said selected pattern may be arranged with a desired design to provide the microfluidic device with desired properties.

In one embodiment wherein the step of partly or totally removing the surface layer with a higher surface tension in a selected pattern of the hydrophilically treated first and/or second surfaces provides the pattern with a surface tension which is less than 80, preferably less than 73, such as less than 60, such as between 20 and 50 mN/m, or even lower than 20 mN/m.

In one embodiment the step of partly or totally removing the surface layer with a higher surface tension in a selected pattern of the hydrophilically treated first and/or second surfaces provides the pattern with a surface tension which is between 25 mN/m above and 10 mN/m below the surface tension of said surface prior to the hydrophilic treatment.

In one embodiment the step of removing the surface layer with a higher surface tension in a selected pattern includes removing between 50 and 100% of a coating applied in the step of hydrophilic treatment, such as between 75 and 100% of a coating applied in the step of hydrophilic treatment. The inventors of the present invention have thus found that the amount of surface layer removed at the removing step (step of removing the surface layer with a higher surface tension in a selected pattern) can be highly controlled to thereby obtain a desired surface energy of the selected pattern.

As mentioned above the desired surface energies of the selected pattern and the surface surrounding the selected pattern and in general the desired surface energies of the entire surface of the flow path are dependent on the liquid sample which is adapted to by used to flow in the microfluidic device.

The liquid sample may thus in principle be any type of liquid sample, organic, inorganic and mixtures. Most often the liquid sample is an aqueous sample e.g. a biological sample, such as any body fluids including blood, urine, and saliva, and suspension or solution of cells, proteins, peptides, hormones and other.

In one embodiment of the microfluidic device and the method of producing it in combination with a selected liquid sample, at least one of said first and second surfaces of the substrates has a contact angle to the selected sample prior to the hydrophilic treatment which is more than 45 degrees, such as more than 50 degrees, such as more than 60 degrees, such as more than 70 degrees.

In one embodiment of the microfluidic device and the method of producing it in combination with a selected liquid sample, the hydrophilic treatment provides at least one of the first and the second surfaces with a contact angle to the selected sample of less than 45 degrees, preferably of less than 30 degrees, such as less than 20 degrees, such as less than 10 degrees, such as less than 5 degrees.

In one embodiment of the microfluidic device and the method of producing it in combination with a selected liquid sample, the step of partly or totally removing the surface layer with a higher surface tension in a selected pattern of the hydrophilically treated first and/or second surfaces provides the pattern with a contact angle to the selected sample which is more than 45 degrees, preferably more than 50 degrees, such as more than 60 degrees, such as more than 70 degrees.

The skilled person will by routine for a specifically selected liquid sample be able to determine the desired surface energies.

The hydrophilic treatment may be performed using any method e.g. the methods generally known in the art. The hydrophilic treatment may preferably be provided by coating the surface, by chemically modifying the surface, by physically modifying the surface or by any combination of these methods.

In one embodiment the hydrophilic treatment is provided by chemically modifying the surface, chemical modification preferably comprising treating the surface with one or more of the treatments selected from the group consisting of gas plasma treatment, corona discharge treatment, UV/ozone treatment, flame treatment, ion beam treatment e.g. using argon and/or oxygen and treatment with oxidizing chemicals, such as acids e.g. chromic acid.

As mentioned above the roughness of the surface has influence on the hydrophilic character of a surface. In situations where the surface tension is relatively high e.g. above 70 mN/m, preferably above 75 mN/m, or where the surface tension is sufficiently high to make a contact angle to a selected liquid sample which is below 90 degree, preferably below 60 degree, the hydrophilic treatment may be a roughening of the surface e.g. using a laser. In this situation the step of removing the surface layer with higher surface tension should comprise melting the surface in the selected pattern to thereby smooth out the roughness of the surface in said selected pattern. Since this method using roughening as the hydrophilic treatment results in only a small difference in surface tension between the surface of the selected pattern and the surrounding surface subjected to the hydrophilic treatment, this method is not the preferred method for general use, but it may be useful for production of some types of microfluidic devices e.g. for providing a section of a flow path (provided with the selected pattern) with a reduced flow speed compared to another section of the flow path (free of the selected pattern).

Thus in one embodiment the hydrophilic treatment is provided by physically modifying the surface by increasing the roughness of the surface, e.g. using laser treatment, and the step of partly or totally removing the surface layer with a higher surface tension using a laser treatment comprises the step of laser treating the surface to at least partly soften or even melt the surface to thereby decrease the roughness of the surface.

In one embodiment the hydrophilic treatment is provided by application of a coating. The coating may be applied using any methods. Examples of methods are plasma deposition, spraying, dipping, printing, vacuum deposition, chemical plating, painting, grafting, immobilization process, hydrogel encapsulation, and ion implantation process e.g. including bombardment with high-energy particles.

Examples of coating compositions include one or more of the compositions selected from the group consisting of cellulose polymers, polyacrylamide, polydimethylacrylamide, acrylamide-based copolymers, polyvinyl alcohol, polyvinylpyrrolidone, polyethylene oxide, Pluronic™ polymers or poly-N-hydroxyethylacrylamide, poly-imines, poly-oxazolines, Tween™ (polyoxy-ethylene derivative of sorbitan esters), silicon polymers (such as siloxanes e.g. pentasiloxane and polyether modified siloxanes) dextran, sugar, hydroxyethyl methacrylene, and indoleactic acid.

It should be observed that this list is not exhaustive and that the skilled person will be able to select other coating compositions which can be used as coating within the scope of this invention.

In general it is preferred that the hydrophilic treatment includes coating using plasma deposition. The plasma deposition may be of any type and often it is preferred to use low energy plasma because the composition of the applied coation is of a higher quality and is possible to provide a highly hydrophilic coating.

Preferred plasma methods are e.g. described in EP 831 679 or WO 00/44207 which, with respect to the method, are hereby incorporated by reference.

The monomers for the plasma may include any components and composition of components which can provide a coherent surface coating in a plasma process and which simultaneously provide a higher surface tension than the surface subjected to the hydrophilic treatment. Examples of monomers include monomers selected from the group consisting of methacrylic acid anhydride, acrylic acid, methacrylic acid, acrylic acid anhydride, 4-pentenoic anhydride, acrolein, methacrolein, 1,2-epoxy-5-hexene, 1-vinyl-2-pyrrolidone, 1-vinyl-2-formamide, R-oxazolines (R being e.g. but not exclusively, methyl, ethyl), ethylene-glycol containing precursors like ethylene-glycol, diethylene-glycol, diethylene-glycol-di-vinylether, diglyme, triglyme, tetraglyme, crown ethers, such as 12-crown-4 ether, 15-crown-5 ether, glycidylmethacrylate, aceto-nitrile, acrylo-nitril, allylamine, allylmercaptane organosilicon compositions such as hexamethyldisiloxane and methoxytrimethylsilane; organophosphorous such as trimethylphosphite and trimethylphosphate; and organoborate such as trimethylborate and triethylborate.

Other examples of monomers for the plasma process include any low molecular weight hydrocarbons e.g. with a molecular weight up to 500, such as methane, ethene, ethane, propene and acetylene.

Furthermore the above mentioned monomers may be deposited in combination with non-polymerisable precursors like oxygen, nitrogen, dinitrogen oxide, carbon dioxide, water, methanol or ethanol. These non-polymerizable precursors will not be chemically linked in the applied coating, but will be entrapped in the network provided by the deposited and polymerized monomers. The entrapped non-polymerizable precursors may have influence on the physical properties of the coating (coherence, strength, hardness e.t.c.), as well as the surface character of the applied coating including its hydrophilic/hydrophobic character.

The thickness applied as a coating may be any thickness as desired, but it is preferred that the coating thickness is relatively thin, since such thin coating will be simple to remove in the step of removing the surface layer with higher surface tension, and furthermore the dimensional step in the surface between surface of selected pattern and its surrounding surface will be small, preferably insignificantly small, so that this dimensional step does not influence the flow along the flow path. In certain situation it is desired that the flow path comprises a dimensional step but in other situation it is not desired.

By using plasma a very thin and homogenous layer can be applied. In one embodiment it is thus preferred that the hydrophilic treatment includes coating the surface, the thickness of the coating preferably being less than 10 μm, preferably less than 1 μm, such as between 0.1 nm and 500 nm, such as between 5 nm and 50 nm.

The coating should preferably have a homogeny thickness along the coated surface.

In most situations it is preferred to subject the entire of the first surface or the entire of the second surface or in certain circumstances the entire of both the first and the second surfaces. However, the hydrophilic treatment may be subjected to a part on one or both of the first and second surfaces. Thus in one embodiment one or both of the first and second surfaces are covered with a mask covering the surface areas which should not be subjected to the hydrophilic treatment before being subjected to a hydrophilic plasma treatment. After the treatment the mask is removed.

The step of partly or totally removing the surface layer with a higher surface tension is preferably performed using a laser treatment.

It has thus been found that by using a laser treatment for step of removing the surface layer with higher surface tension, this removing step can be controlled with high precision, so that a desired pattern can be obtained and that a desired thickness layer can be removed.

Preferably the laser treatment is performed using a laser which is capable of providing an absorbed energy density at the surface sufficient to remove (e.g. ablate) at least a part of the surface layer having a higher surface tension.

The laser used may be any laser which is capable of emitting a laser beam as wavelength which can be adsorbed by the surface to be treated (the surface in the selected pattern). The skilled person will for a given surface be able to find a useful laser.

Preferred lasers include a CO₂ laser or an UV laser, preferably an UV excimer laser.

During part or all of the laser treatment a flow of an inert gas, such as helium may be provided along the surface to be treated to remove the evaporated part of the surface layer. Thereby re-deposition of once removed material can be avoided.

The energy applied onto the treated surface during the laser treatment in the selected pattern may preferably be between 100 and 10000 mJ/cm², such as between 200 and 2000 mJ/cm², such as between 250 and 1000 mJ/cm².

The laser treatment may in one embodiment be performed using a mask. The mask may in one embodiment correspond to the selected pattern. In another embodiment the mask and substrate are moved relative to each other during the laser treatment to thereby provide the selected pattern.

By performing the laser treatment by moving the mask and substrate relative to each other, the mask may be reused for several different microfluidic devices with varying pattern.

The thickness layer removed by the step of removing the surface layer with higher surface tension in the selected pattern may preferably be in the interval of 0.1 nm-10 μm, preferably between 0.1 nm-500 nm. The skilled person will know that the thickness layer removed naturally may be even higher, and further it is clear that the thickness layer removed may vary along the selected pattern e.g. to provide a selected pattern with areas of different surface tension e.g. step wise varying or gradually varying along the pattern.

The pattern provided by the step of removing the surface layer with higher surface tension may have any shape and size. This novel method of the present invention has thus provided a valuable tool for producing microfluidic devices with desired flow path character, and furthermore this invention has opened for production of completely new types of microfluidic devices with desired properties which have not been possible to produce or been considered to be produced prior to the date of this invention.

In the following several desired patterns will be described without limiting the invention to this pattern.

The liquid sample flow direction means in the following the indented flow direction of a liquid sample as determined in relation to the inlet. I.e. the direction along a flow path, which a liquid sample will flow or is indented to flow when introduced into the inlet. The term “flow direction” means the liquid sample flow direction or the direction opposite the liquid sample flow direction.

Due to the method provided according to the invention it is possible to provide a microfluidic device wherein the selected pattern is a micropattern comprising one or more pattern segments with at least one dimension less than 250 μm, preferably less than 200 μm, such as less than 150 μm, such as less than 100 μm, such as less than 50 μm, such as less than 25 μm, preferably less than 10 μm, such as less than 5 μm.

In one embodiment the micropattern comprises one or more pattern segments with at least one dimension less than the depth of the flow path (the distance between the first and the second surfaces).

These pattern segments may e.g. be lines with a width within the above dimension.

In one embodiment the selected pattern is a micropattern comprising a plurality of microdots having dimensions up to 30 μm, such as up to 25 μm, such as up to 20 μm, such as up to 15, μM, such as between 1 and 20 μm. The major part (50% by number or more) of the microdots may preferably have shortest distance to the closest microdot which is 30 μm or less, such as up to 25 μm, such as up to 20 μm.

By arranging the plurality of microdots e.g. in a periodic pattern over the flow path, different properties may be obtained, e.g. a delaying section may be provided. If the microdots are placed closer to each other than the depth of the flow path, an array of such microdots may completely block the capillary flow along the flow path.

If the microdots are placed in a line with a distance less than the depth of the flow path, this microdot line may act as if it was a true line except that a microdot line will be faster wetted e.g. from one of its ends than a true line.

In the pattern described below it should thus be understood that a line could be a true line or a line of microdots with a distance less than the depth of the flow path.

The individual microdots may have any shape e.g. one or more of the shapes selected from round, oval or angular, such as triangular, square, rectangular, pentagonal and hexagonal, and other euclidic forms. Often it is most simple to make the microdots essentially circular.

In one embodiment the selected pattern extends totally or partly across a flow path. If the selected pattern extends totally across the flow path, this pattern will either delay a flow or block a flow along the flow path, depending of the surface tension in the selected pattern and the dimension of the pattern.

In one embodiment the selected pattern comprises a pair of barrier lines extending from respective borderlines of the flow path and towards each other to provide a narrow opening between the pair of barrier lines. The distance between the pair of barrier lines preferably is less than the depth of the flow path, such as less than 50% of the depth of the flow path. In one embodiment the distance between the pair of barrier lines is 50% or less of the width of the path between the borderlines from where the pair of barrier lines contact said borderlines. In one embodiment the distance between the pair of barrier lines preferably is less than 250 μm, such as less than 200 μm, such as less than 150 μm, such as less than 100 μm, such as less than 50 μm, such as less than 25 μm, preferably less than 10 μm, such as less than 5 μm.

If the distance between the barrier lines becomes too small e.g. less than the depth of the flow path, the barrier lines may completely block the capillary flow. Often it will be desired to use such pairs of borderlines to delay a flow along the flow path. Thus in one embodiment the selected pattern comprises a plurality of pairs of barrier lines, the barrier lines preferably being placed at a distance to each other along a flow path. The distance along the flow path may e.g. be between 10 and 500 μm.

The one or more pairs of barrier lines, may preferably be pair wise parallel. In one embodiment the respective pairs of barrier lines preferably have an angle to the borderlines of the flow path which is between 80 and 100 degrees, more preferably about 90 degrees.

In one embodiment the one or more pairs of barrier lines, pair wise have an angle to each other, e.g. an angel between 90 and 135 degrees. The respective pairs of barrier lines may preferably have an angle to the borderlines of the flow path which is between 45 and 135 degrees, such as between 55 and 80 or between 100 and 125 degrees.

In use a liquid sample will be delayed or stopped by the one or more pairs of barrier lines. If it is stopped an external force has to be applied for the liquid to pass the pair(s) of barrier lines. After the one or more pairs of barrier lines have been wetted, they no longer constitute any delaying or blocking elements, and the liquid will simply flow over the pair(s) of barrier lines as if they were not there at all.

In one embodiment the selected pattern comprises one or more pairs of cross flow lines extending from respective border lines of the flow path and towards the respective opposite borderline of the flow path. The pairs of cross flow lines do not reach said opposite borderline but leave a gap between the respective cross flow line and the opposite borderline. The pair of cross flow lines are placed with a distance seen in the liquid sample flow direction of e.g. 5 μm or more. More preferably the distance in flow direction is between 5 and 100% of the width of the path. The distance may preferably be determined as the minimal distance in flow direction.

The selected pattern may in this embodiment preferably comprise a plurality of pairs of cross flow lines, the cross flow lines preferably being placed at a distance to each other along a flow path.

In use a liquid sample will be delayed by the one or more pairs of cross flow lines. After the one or more pairs of cross flow lines have been wetted, they no longer constitute any delaying elements, and the liquid will simply flow over the pair(s) of cross flow lines as if they were not there at all. In one embodiment the pairs of cross flow lines comprise an increased section e.g. shaped as a dot closest to the opposite borderline (the borderline it does not contact). Thereby the wetting process may be delayed as the liquid sample flows along the flow path.

In one embodiment one or more of the cross flow lines comprise a one-way vent as disclosed below. The one-way vent is closed in the direction pointing towards the inlet, i.e. a flow in the liquid sample flow direction will be blocked until the one-way vent has been wetted from the other side of the cross flow line, when the liquid has passed onto said side. In this embodiment a slight mixing of the liquid sample may be performed.

In one embodiment the selected pattern comprises an island shaped segment. The island shaped segment preferably is formed by a totally or partly surrounding flow blocking line, the central part of the island optionally having the surface layer of the higher surface tension.

Such an island shaped segment may be used for applying a reagent to the liquid sample. The reagent is applied onto the central part of the island with a surface layer of the higher surface tension, whereby the reagent, which is often in the form of an aqueous solution or dispersion, is spread onto the central part of the island with a surface layer of the higher surface tension, but without passing the selected pattern in the form of a totally or partly surrounding flow blocking line. The reagent may be dried prior to the step of joining the base and top substrates to each other.

In one embodiment the blocking line extends at least across 50% or more, such as 75% or more, such as 90% or more of the flow path on the side of the island facing towards the flow front in use (i.e. facing towards the inlet). Preferably the blocking line at least extends across a sufficient part of the flow path on the side of the island facing towards the flow front in use, so that an optional opening is less than the depth of the flow path. The optional opening in the blocking line of the flow path on the side of the island facing towards the flow front in use, preferably is less than 100 μm, preferably less than 50 μm, such as between 25 and 100 μm.

The blocking line may in one embodiment be arranged so that it blocks a flow of the liquid sample along the flow path from entering and/or passing out of the island shaped segment. External forces may thus be applied to help the liquid sample crossing the blocking line.

In one embodiment the blocking line is equipped with a one-way valve as described below, whereby the reagent will be blocked by the blocking line when applied to the central part of the island with a surface layer of the higher surface tension, but the liquid sample can flow through the one-way valve into the island shaped segment to come into contact with the reagent.

The gaps and the thickness of the blocking line may in one embodiment be arranged so that the liquid flow of the liquid sample may be delayed from passing out of the island shaped segment, to thereby provide a desired time for the liquid sample to dilute and optionally react with the reagent.

In one embodiment the blocking line at least extends across 50% or more, such as 75% or more, such as 90% or more around the island, the optional gap(s) provided in the surrounding blocking line preferably being each less than 100 μm, preferably less than 50 μm, such as between 25 and 100 μm.

In one preferred embodiment of the microfluidic device, the selected pattern forms a one-way valve. It has thus been found that it is possible to provide a one-way valve by arranging a pattern with a lower surface tension than the surface tension of the adjacent surface area. The selected pattern extends totally or partly across a flow path to provide a hydrophobic barrier, and is arranged with a geometry to provide a capillary stop in one flow direction, but not in the opposite flow direction.

In one embodiment wherein the selected pattern forms a one-way valve, the selected pattern is arranged with a geometry so that the forces needed to overcome the hydrophobic barrier from one side of the flow path are higher than the forces needed from the other side of the flow path. This may e.g. be arranged by providing a gradually increasing or decreasing surface tension along a section of the flow path in the liquid sample flow direction.

In one embodiment the selected pattern is arranged with a geometry totally across the flow path so that a width section across the flow path at a distance of the border lines of the flow path comprises a narrowing hydrophobic barrier segment than across the remaining part of the flow path.

In one embodiment the selected pattern has a V-shaped front. The one-way valve provided by the V-shaped pattern may in one embodiment have its open end (the end with the two legs of the V-shape) arranged to face a liquid flow front along the flow path i.e. it is facing towards the inlet. A liquid sample flowing in the liquid sample flow direction will be blocked (temporary stop or full stop) by the one-way valve, e.g. because the liquid front will be stopped by an air bubble trapped near the tip, between the legs of the V-shaped pattern due to the surface tension between the surface, the liquid sample and the air. In another embodiment the one-way valve provided by the V-shaped pattern has its open end arranged to face away from the inlet. In this situation, a liquid sample flowing in the liquid sample flow direction will flow over the one-way valve by initially wetting the tip of the V-shape, and thereafter gradually wetting the remaining part of the hydrophobic pattern.

In one embodiment the selected pattern is formed as a belt with one or more narrowing hydrophobic barrier segment(s) provided by one or more V-shaped notches in one side of the belt shape. The V-shaped notch may in one embodiment be formed in the side of the belt shape facing towards the inlet. Thereby a liquid sample flowing in the liquid sample flow direction will be blocked (temporary stop or full stop) by the one-way valve. In another embodiment the V-shaped notch is preferably formed in the side of the belt shape facing away from the inlet. Thereby a liquid sample flowing in the liquid sample flow direction will flow over the one-way valve by initially wetting the tip of the V-shape, and thereafter gradually wetting the remaining part of the hydrophobic pattern.

The legs of the V-shape may in principle have any angle to each other, but it is preferred that the V-shape has an angle between its legs which is less than 120 degrees, preferably less than 100 degrees, such as less than 90 degrees. The smaller the angle is, the faster the V-shaped pattern will be wetted from the tip direction. In practice the angle between its legs can be down to about 30 degrees.

The V-shaped pattern may function equally well even if the tip is missing. In this situation the wetting from the tip side may be even faster than in situation where the tip is complete.

In one embodiment wherein the selected pattern is arranged with a geometry partly across the flow path so that a flow path width section across the flow path at a distance of the border lines of the flow path is free of the selected pattern, the flow path width section preferably has a width which is less than 100 μm preferably less than 50 μm, such as between 25 and 100 μm. The flow path width section may correspond to the missing tip of the V-shape.

Thus in a preferred embodiment the selected pattern has a tip free V-shaped front, the pattern free flow path width section is provided between the legs of the V-shape instead of a tip. The tip free V-shape may be arranged as the V-shape above.

Similarly the selected pattern may in one embodiment be formed as an interrupted belt, wherein the one or more interruption(s) is/are provided by the pattern free flow path width section(s) in the form of one or more tip free V-shaped intersect(s) through the belt shape.

The tip free V-shaped valve may have any angle e.g. an angle between its legs which is less than 120 degrees, preferably less than 100 degrees, such as less than 90 degrees. In practice the angle between its legs can be down to about 30 degrees.

In one embodiment the selected pattern extends totally or partly across the flow path and comprises a V-shaped pattern, which may optionally being tip-free. The V-shape is provided by barrier lines having an equal or varying thickness, such as a thickness which is broader closer to a borderline of the flow path than closer to a middle line along the flow path at equal distances to its two borderlines along the flow path.

In one embodiment the capillary stop is a full stop, or a temporary stop. It is generally desired that the temporary stop preferably provides a capillary stop of at least 1 second, such as of at least 5 seconds, such as of at least 10 seconds, such as of at least 30 seconds, such as up to 1 minute, such as up to 5 minutes, such as up to 10 minutes. In case of a full stop, external forces may be applied to pass the temporary stop.

In one embodiment of the microfluidic device of the invention and the method of producing it, the selected pattern comprises two one-way valves placed in a flow path at a distance from each other, the distance between the two one-way valves forms an island shaped segment e.g. as disclosed above. The two one-way valves may be arranged to provide capillary stops out of the island shaped segment in both directions of the flow path.

In one embodiment of the microfluidic device and the method of the invention, the selected pattern forms one or more segmentation lines, segmenting a flow path into 2 or more flow path segments. The selected pattern preferably comprises a plurality of segmentation lines and thereby a plurality of flow path segments.

The segmentation lines may preferably have a direction essentially parallel to the flow direction, however, in certain embodiments the segmentation lines may be slightly angled or wave shaped compared to the flow direction. If there is more than one segmentation line, these segmentation lines are preferably essentially parallel to each other.

The segmentation lines may preferably be provided to provide one or more flow path segments which have widths which are sufficiently low to provide a flow delay. The optimal width is highly dependent on the depth of the flow path. Preferably the width of the flow path segments should be less than the depth of the flow path. Preferably the respective flow path segments have a width of less than 250 μm, preferably less than 200 μm, such as less than 150 μm, such as less than 100 μm, such as less than 50 μm, such as less than 25 μm, such as less than 10 μm.

In this embodiment comprising two or more flow path segments it is desired that at least one of the first and second surfaces of the flow path in the respectively flow path segments has a surface tension above 75 mN/m, preferably above 85 mN/m.

As the flow path segments are very narrow, a liquid sample which is flowing along the flow path may loose contact with one of the first and second surfaces, usually the one of the surfaces with the lowest surface tension, but a capillary flow may continue in a film layer onto the surface having the higher surface tension, in particular if the surface tension is above 75 mN/m.

Preferably the contact angle between said hydrophilic surface and the liquid sample is approaching 0 (e.g. below 5 degrees). This capillary film flow may result in a filtration of the liquid sample, as larger molecules may be captured along the flow path segments.

In one embodiment the selected pattern forms a full stop hydrophobic barrier extending totally across the flow path, the full stop hydrophobic barrier preferably being placed adjacent to the exit of the flow path. Such a full stop hydrophobic barrier may prevent liquid from escaping out of the microfluidic device even though air freely can pass out of an exit of the microfluidic device.

In one embodiment the selected pattern with a lower surface tension on at least one of the first and second surfaces of the flow path has a shape along the flow path to provide a hydrophobic border line. The flow path is provided with a sufficient hydrophilic character to provide a flow along the flow path in the step of hydrophilic treatment.

As mentioned above the method may further comprise the step of hydrophobically treating at least one of the first and the second surfaces to provide a surface layer with a lower surface tension than the surface tension prior to the hydrophobic treatment. Thereby the hydrophobic pattern may be as hydrophobic as desired irrespectively of the bulk material used for the base and top substrates.

The step of hydrophobically treating at least one of the first and the second surfaces may preferably be performed prior to the step of hydrophilically treating at least one of the first and the second surfaces. The surface(s) subjected to the hydrophobic treating preferably also being subjected to the hydrophilic treating.

As an example it should be mentioned that the surface(s) of the substrate(s) to be treated preferably may have a surface tension prior to the hydrophobic treatment which is above 30, preferably above 35 mN/m, such as between 37 and 80 mN/m. In case the surface(s) of the substrate(s) to be treated has a lower surface tension only marginal improvement may be obtained by performing the hydrophobic treatment. The hydrophobic treatment may e.g. be performed directly onto the bulk material of the substrate, or alternatively the surface(s) to be treated may have one or more coatings.

The hydrophobic treatment may e.g. provide at least one of the first and the second surfaces with a surface tension of less than 50, preferably of less than 40, such as less than 30, such as less than 20 mN/m or even less.

The hydrophobic treatment may preferably decrease the surface tension with at least 5 mN/m, such as at least 10 mN/m, such as at least 15 mN/m, such as at least 20 mN/m, compared to its initial surface tension prior to the hydrophobic treatment.

In situation where the microfluidic device has been subjected to a hydrophobic treatment it is desired that the step of partly or totally removing the surface layer with a higher surface tension in a selected pattern of the hydrophilically treated first and/or second surfaces, at least partly exposes the hydrophobic layer provided by the hydrophobic treatment in at least a part of the selected pattern.

In one embodiment the step of partly or totally removing the surface layer with a higher surface tension in a selected pattern of the hydrophilically treated first and/or second surfaces, also includes partly or totally removing the layer provided by the hydrophobic treatment in the selected pattern.

In one embodiment the step of partly or totally removing the surface layer with a higher surface tension in a selected pattern of the hydrophilic treated first and/or second surfaces provides the selected pattern with a surface tension which is less than the surface tension of the bulk material of the substrate. The selected pattern may thus have two or more pattern sections which have surface tension different from each other.

The hydrophobic treatment may be provided by any methods such as the methods generally known in the art and including coating the surface and/or chemically modifying the surface.

Preferably the hydrophobic treatment is provided by application of a coating, the coating may preferably be applied using one or more of the methods selected from the group consisting of plasma deposition, spraying, dipping, printing, vacuum deposition, chemical plating, grafting and immobilization process, hydrogel encapsulation.

More preferably the hydrophobic treatment includes coating using plasma deposition, optionally using one or more of the monomers selected from the group consisting of acid halogenides, such as acrylic acid chloride and methacrylic acid chloride, fluorocarbons such as perfluoroalkanes, perfluoroalkenes such as tetrafluoroethylene and hexafluoropropene, perfluorocycloalkanes; hydrocarbons such as alkanes and alkenes such as ethylene, acetylene, propene, 1-hexene; partly substituted hydrocarbons like C₂F₂H₂; or 1,2-epoxy-3-phenoxy-propane.

The thickness of the hydrophobic plasma coating may be as the thickness of the hydrophilic plasma coating as specified above e.g. the thickness of the coating preferably being up to 1 μm, such as between 25 nm and 500 nm

In a variation of the method according to the invention the method of producing a microfluidic device having at least one flow path, the method comprises the steps of
i. providing a base substrate with a first surface and a top substrate with a second surface,
ii. hydrophobically treating at least one of the first and the second surfaces to provide a surface layer with a lower surface tension than the surface tension prior to the hydrophobic treatment,
iii. partly or totally removing the surface layer with a lower surface tension in a selected pattern of the hydrophobic treated first and/or second surfaces, to thereby provide the selected pattern with a higher surface tension than prior to the partly or totally removal of the surface layer with a lower surface tension in said selected pattern of the hydrophobically treated first and/or second surfaces, and
iv. joining said base substrate and top substrate to each other to provide a flow path between said first and second surfaces.

The steps i. and iv. are identical to the steps as disclosed above. Instead of subjecting the surface to a hydrophilic treatment and removing part of this to provide a hydrophobic pattern, this method comprises subjecting the surface to a hydrophobic treatment and removing part of this to provide a hydrophilic pattern. The methods of performing the hydrophobic treatment may be as disclosed above. The step of removing the surface layer with lower surface tension may be as the step of removing the surface layer with higher surface tension as disclosed above, the thickness and design provided by this method may also be as above where the hydrophilic pattern is the negative of the hydrophobic pattern (or selected/desired or just pattern) as disclosed above, i.e. the hydrophilic pattern corresponds to the part of the surface subjected to hydrophilic treatment and not including the hydrophobic pattern above.

In one embodiment of this variant of the method the selected pattern with a higher surface tension on at least one of the first and second surfaces of the flow path has a shape along the flow path arranged to provide the flow path with a sufficient hydrophilic character to provide a flow along the flow path.

The invention also relates to a microfluidic device obtainable according to the methods as disclosed above optionally in combination with a liquid sample. This microfluidic device may preferably be as already disclosed above. Furthermore in one embodiment the selected pattern may preferably have a roughness which is higher than the roughness of the surrounding surface.

The invention also relates to a microfluidic device with at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a micropattern in the hydrophilic surface area, the micropattern comprising one or more pattern segments with at least one dimension less than 250 μm, preferably less than 200 μm, such as less than 150 μm, such as less than 100 μm, such as less than 50 μm, such as less than 25 μm, preferably less than 10 μm, such as less than 5 μm.

The microfluidic device with such a hydrophobic micropattern may be as described above but independent of the method of providing it.

The invention also relates to a microfluidic device with at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a pattern in the hydrophilic surface area, the pattern comprises an island shaped segment, the island shaped segment preferably being formed by a totally or partly surrounding flow blocking line, the central part of the island shaped segment, optionally having the surface layer of the higher surface tension, optionally the device comprises a reagent applied onto the central part of the island shaped segment.

The microfluidic device with such an island shaped segment may be as described above but independent of the method of providing it.

The invention also relates to a microfluidic device with at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a pattern in the hydrophilic surface area, the pattern comprises one or more pairs of cross flow lines extending from respective border lines of the flow path and towards the respective opposite borderline of the flow path, optionally one or more of the flow lines comprises a one-way valve.

The microfluidic device with such one or more pairs of cross flow lines may be as described above but independent of the method of providing it.

The invention also relates to a microfluidic device with at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a pattern in the hydrophilic surface area, the pattern forms a one-way valve, the selected pattern extent totally or partly across a flow path to provide a hydrophobic barrier, and is arranged with a geometry to provide a capillary stop in one flow direction.

The microfluidic device with such a one-way valve may be as described above but independent of the method of providing it.

The invention also relates to a microfluidic device with at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a micropattern in the hydrophilic surface area, the pattern forms one or more segmentation lines, segmenting a flow path into 2 or more flow path segments, the selected pattern preferably comprises a plurality of segmentation lines, and thereby a plurality of flow path segments.

The microfluidic device with such one or more segmentation lines may be as described above but independent of the method of providing it.

A microfluidic device of this type may preferably be used as a filter e.g. to filter beads with immobilized antibodies from the sample as well as filtering blood cells from plasma.

In a variation of the microfluidic device invention comprising a filter the microfluidic device with at least one flow path comprises a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a hydrophobic stop line across the flow path (e.g. provided by a number of hydrophobic patches extending across the flow path) the area immediately after the flow stop in the liquid sample flow direction is highly hydrophilic preferably with a contact angle to the liquid sample around 0. An example of such a microfluidic device is shown in FIG. 1.

### Laser Cutting Test

This example shows the effect of laser cutting in PVP-coated plastic surfaces with different energies.

The laser used was an Optec Micromaster 248 nm excimer-laser. The chips were standard (PS-polymer) SMB 50×20 format without structure (blanks) that had previously been coated with a coating of PVP10, thickness 120 Å, with control measurement showing all surfaces to have contact angles below 10°. All contact angles were measured towards water.

Laser settings: Laser aperture of 500×500 μm² with a 250 μm motor step size. The energy per laser pulse was kept constant at 12 mJ/pulse and the number of pulses then varied to give the desired fluence.

In FIG. 13 at the highest laser fluence, a marked zone of molten poly-styrene rings the quadratic, excimered area. On all excimered areas, horizontal scan lines arising from the finite aperture of the laser are observed. A very noticeable difference between the surfaces is how well the surfaces reflect light. The highest reflection of light (for the chips shown) is observed for the chip excimered at 535 mJ/cm². At higher and lower excimer fluences the reflectance drops. At 202 mJ/cm² it is still possible for the trained eye to observe the excimered area as a higher reflecting region compared to the black PS-background, but below this fluence, the excimered area can no longer be discerned. At 1782 and 1069 mJ/cm² material visibly evaporates from the surface while the laser is on. This is not the case for any other of the fluences tested. On the contrary, to the eye the surface does not seem to chance in smoothness though the underlying poly-styrene has been excimered.

For all excimered regions the contact angle to water was measured. This was done at SMB using water droplets of 10 μl volume. The static contact angles were evaluated using a contact angle evaluation program from First Ten Ångstrøms, Inc. and are reported as the average of left and right side of the drop. In FIG. 14, these results are plotted as a function of laser fluence. Two regions of interest can be discerned in the figure, one at fluences below 400 mJ/cm², where the contact angle increases from 10° to 60° and a second region at higher fluences, where the contact angle averages the contact angle of PS to water of 85°.

It is known from previous experiments that a PVP-film will vary its contact angle to water from wetting up to around 60° as the degree of cross-linking within the polymer is increased. Contact angles above 60° have never been observed with films retaining a predominant PVP-character. This gives strong indication that beyond 400 mJ/cm² the PVP-coated layer is completely excimered away leaving only the PS of the chips.

Using the Dektak at SMB, Dektak 3030ST from Veeco Instruments Inc., Santa Barbara Calif., the roughness across the excimered regions was measured and the results are shown in FIG. 15 as a function of fluence. As can be seen from the two graphs of FIG. 15, the roughness increases dramatically with increasing laser fluency, from a roughness of below 15 nm at fluencies below 300 mJ/cm² up to a roughness in one instance of 1200 nm at 1782 mJ/cm².

Again as could be seen from FIG. 13, the surfaces where the PVP-film has been excimered away are strongly different from those, where it is retained. And although the roughness will go up as the fluence is increased from 300 mJ/cm² to 400 mJ/cm², the roughness only increases from 15 to 30 nm, whereas the roughness increases from 30 nm to 100 nm upon increasing the fluence from 400 to 500 mJ/cm², i.e. into the region of fully removed PVP.

It is surprising to find that the surface roughness does not increase over the initial level of about 10 nm below a fluence of 300 mJ/cm² given that scan lines from the laser are visible even at 202 mJ/cm².

### BRIEF DESCRIPTION OF DRAWINGS

Examples of embodiments of the invention will be described below with references to the drawings:

FIG. 1 shows a perspective view of a base substrate of a microfluidic device according to the invention.

FIG. 2 is sectional cut of a microfluidic device in general.

FIGS. 3-10 are top views of various base substrates of a microfluidic device according to the invention.

FIGS. 11 and 12 show cross sections of injected molded and coated polymer parts with laser treated surface sections.

FIGS. 13-15 show pictures and curves of the laser cut test described above.

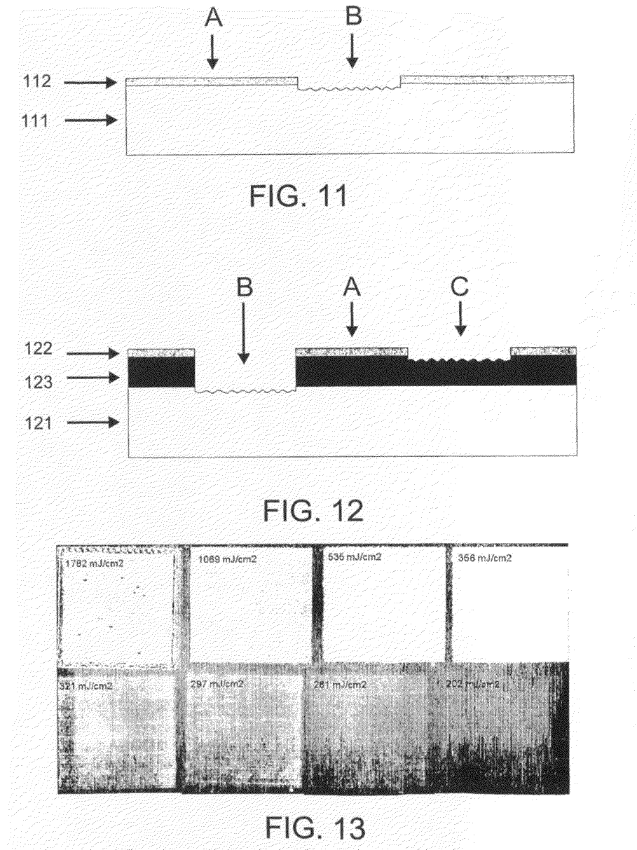

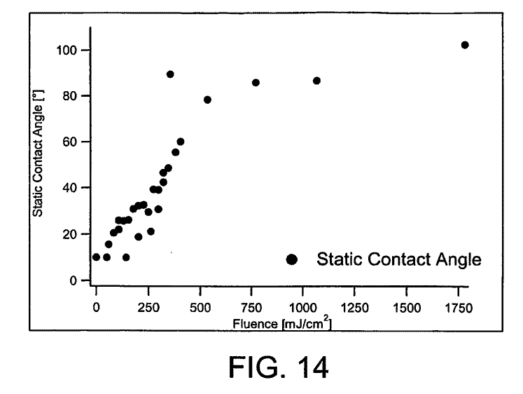

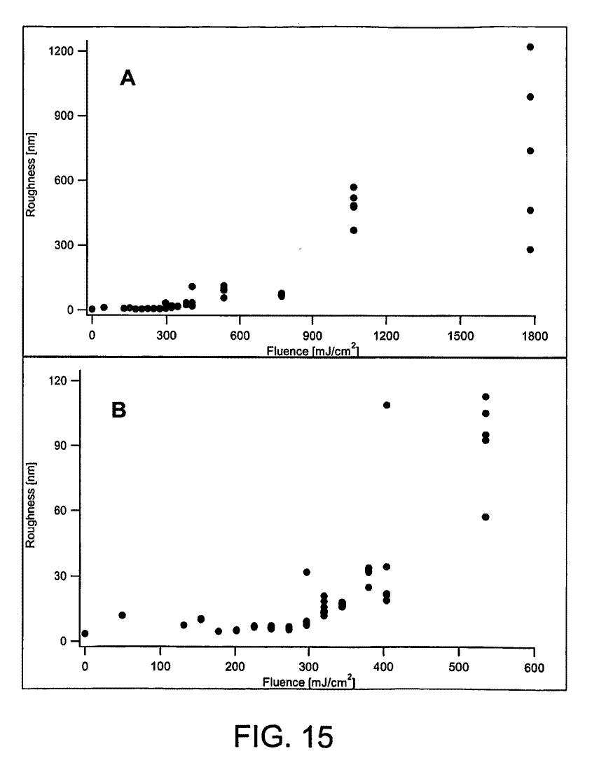

FIG. 11 shows a cross section of an injection molded polymer part 111. The polymer part 111 is coated with a very thin hydrophilic coating 112 (equivalent water contact angles in the range 3-20 degrees). The coating 112 has been laser ablated away from the surface in an area B thereby making the surface of the molded part available at the surface. The molded part is typically hydroneutral (equivalent water contact angles in the range 70-110 degrees). A liquid in contact with the surface will thus experience a contact surface tension that can be either hydroneutral (B) or hydrophilic (A) depending on the pattern removed by the laser ablator.

FIG. 12 shows a cross section of an injection molded polymer part 121. The polymer part 121 is coated with two different coatings a hydrophilic coating 122 on top of a hydrophobic coating 123. The hydrophilic coating 122 is very thin and the hydrophobic coating 123 is somewhat thicker.

The coatings 122, 123 can be removed by laser ablation to uncover the different materials below with different surface tension. Without laser ablation the hydrophilic coating 122 is on the surface, with a shallow laser ablation the hydrophobic coating 123 is uncovered and with a deep laser ablation the hydroneutral 121 base material is uncovered. A liquid in contact with the surface will thus experience a contact surface tension that can be either hydrophilic (A), hydroneutral (B) or hydrophobic (C) depending on the pattern removed by the laser ablator.

FIG. 2 shows a microfluidic device with a base substrate 11 and a substrate 12 defining a flow path 13 in the form of a channel 13. The borderlines of the flow path 13 are defined by the edge surfaces 14. In an alternative embodiment which is not shown the borderlines of the flow path are defined by a hydrophobic borderline as described. The figures as describe in the following only show a part of a microfluidic device, namely the surface of the base substrate/top substrate constituting the flow path. It should be understood that these surfaces are parts of whole microfluidic devices where the non shown parts may be as disclosed in the previous description.

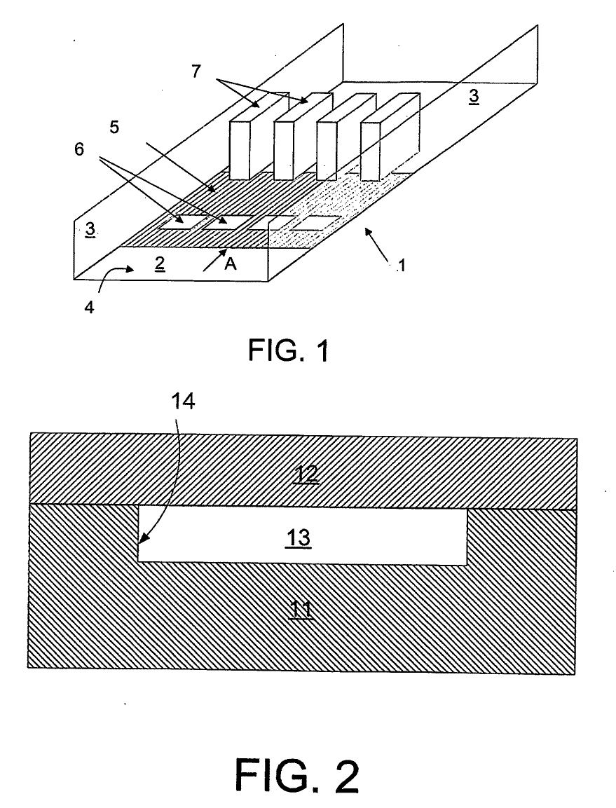

FIG. 1 shows a base substrate 1 of a microfluidic device according to the invention. The base substrate 1 comprises a flow path 2 defined by the edge 3 of a channel in the base substrate 1. The liquid sample flow direction is indicated with the arrow A.

The surface of the flow path 2 comprises three or more surface areas with different surface tension. The first surface area 4 is a general hydrophilic surface area 4, which is sufficiently hydrophilic to provide an ordinary capillary flow when the top substrate is joined to the base substrate. The top substrate may have any surface tension but preferably not too low, e.g. as disclosed above. The second surface area 5 is a highly hydrophilic surface area which preferably has a surface tension which is sufficiently high to provide a contact angle between the liquid sample and the surface which is approximately 0. The third surface area is in the form of a number of hydrophobic patches 6 extending across the flow path 2. The shown base substrate 1 further comprises protruding flanges 7 which have a respective hydrophilic surface and which act as flow elevators as it will be explained in the following. It should be observed that in an alternative embodiment the base substrate does not comprise such protruding flanges 7.

The geometrical and surface tension structuring provided in the flow path 2 provides the microfluidic device with a filter function

In use the liquid sample containing the particles to be filtered passes along the liquid sample flow direction, until it meets the number of hydrophobic patches 6 extending across the flow path 2. These patches 6 constitute a capillary stop where the main flow stops. The section between hydrophobic patches 6 and after the hydrophobic patches 6 with the highly hydrophilic surface area 5 constitutes a filter section where the sample will flow past the capillary stops through thin surface defined pores thereby leaving the particles behind. The flow will only be in contact with one of the surfaces of the microchannel 4 in the filter section. After having passed the filter section the liquid sample will come into contact with the hydrophilic surface of the protruding flanges 7 where the filtered sample is brought in contact with all the sides of the channel 4 again, and the capillary flow may be reestablished.

The capillary stop consists of a number of hydrophobic patches 6 extending across the channel. Even though there are narrow hydrophilic areas between these hydrophobic patches, the sample cannot pass between the hydrophobic patches. To prevent the sample from entering the gap between the hydrophobic patches in the form of a capillary flow, the distance between the patches must be less than two flow path heights. (This assumes around 90 degree contact angle at the top substrate, 80-110 degrees at the hydrophobic patches and 10 degrees on all other surfaces). If the top substrate is very hydrophilic the exclusion begins at one channel height distance between the hydrophobic patches.

In effect the hydrophobic patches 6 act as capillary stops for the sample flow. The flow exclusion between the hydrophobic patches 6 is only valid as long as the sample is in contact with the top substrate. When the sample has stopped at the capillary stop, the sample will start to creep across the hydrophilic surface between the hydrophobic patches. For this to occur the hydrophilic surface in the gaps has to be wettable (surface at least hydrophilic enough to give a contact angle of 0 degrees). This may preferably be done by structuring the base so it has a rough surface so it becomes easy to wet. For the filter function to be optimal this roughening of the surface is best made as very narrow grooves extending perpendicular to the capillary stop.

If the wetting nature of the hydrophilic flow paths is made by surface chemistry, the sample will creep across the wettable surface in a very thin layer. The height of this layer is determined by the ratio of the surface tension of sample and air to wetting surface to sample. Typical heights are a few micrometers, thus preventing particles larger than this from passing the hydrophilic flow path.

If the wetting nature of the hydrophilic flow paths is made by a rough surface, the height of the flow path is given by the minimum and maximum height of the rough surface. Making the rough surface by microstructuring, the height of the flow path can be controlled very accurately.

As the sample creeps across the surface it leaves the particles behind because they cannot fit into the hydrophilic flow path. By making a fine surface structuring, it is possible to filter e.g. red blood cells from blood.

When the filtered sample has passed the hydrophobic patches 6 it is desired to bring the filtered sample in contact with all the channel surfaces again. This is to reduce the length of the surface flow which has a high flow resistance. The sample is brought in contact with the top substrate by using a structure having a high capillarity in the direction toward the top substrate. This can in a not shown embodiment be done by gradually reducing the channel height (also called the flow path depth) until it is in proximity of the top substrate, and the sample will thus get in contact with the top substrate. Another method is to use a number of hydrophilic flanges 7 extending from the channel bottom toward the lid. Between the slits there is a large hydrophilic area thus giving a high capillarity which fills the volume between the flanges 7 and eventually brings the sample in contact with the lid. After this flow elevator the filtered sample proceeds in the output channel in the same way as it did before meeting the capillary stop.

This filter can e.g. be used to filter beads with immobilized antibodies from the sample as well as filtering blood cells from plasma.

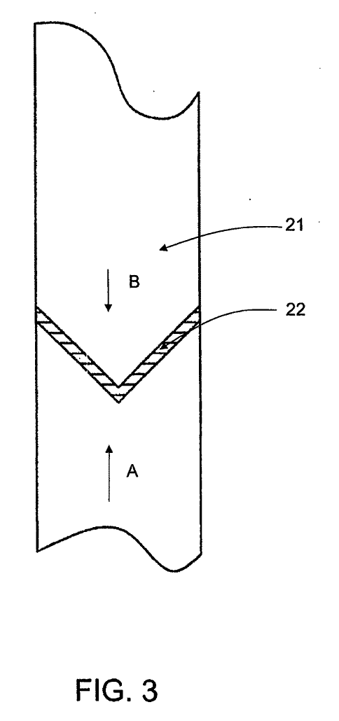

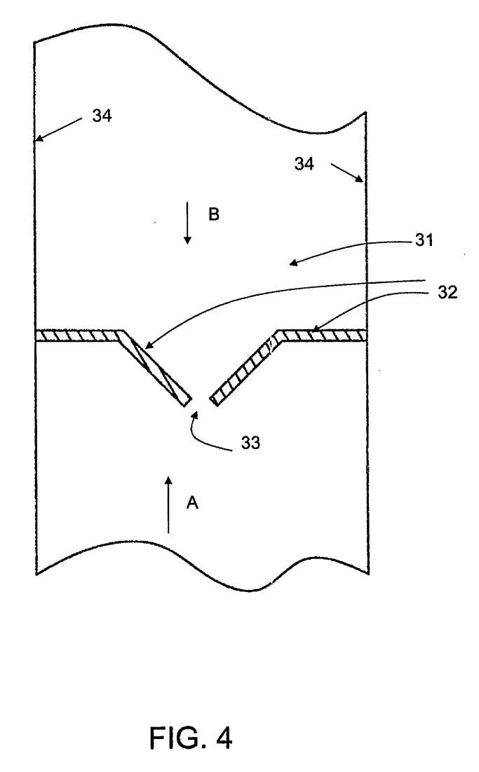

The FIGS. 3-10 show the flow path surfaces of base substrates and/or top substrates with different hydrophobic pattern. As mentioned above these surfaces naturally constitute parts of whole microfluidic devices, wherein one or both of the base substrates and/or top substrates comprise the described pattern. As mentioned in the description above it is most often sufficient that only one of the two substrates comprises the hydrophobic pattern.

FIG. 3 shows a flow path with a hydrophobic pattern shaped to form a V-shaped one-way valve. The flow path comprises a generally hydrophilic surface area 21 with a hydrophobic pattern 22 in the form of a V-shape.

If the liquid sample flows in the flow direction B, the flow will be completely or temporarily stopped by the V-shaped hydrophobic pattern 22. Due to the surface energies of the various materials, the hydrophilic surface 21, the hydrophobic pattern 22, the liquid sample (which is often hydrophilic) and the air, the liquid flow front will be pinned near the tip between the two legs of the V-shaped pattern, and thereby the flow will be stopped.

If the liquid sample flows in the flow direction A, the liquid front will travel down the legs of the V-shape and drag itself over the tip of the V-shaped pattern, and thereby break through the valve structure and gradually wet the remaining of the hydrophobic pattern.

FIG. 4 shows a flow path with a hydrophobic pattern which is similar to the hydrophobic pattern shown in FIG. 3. The hydrophobic pattern is also here shaped to form a V-shaped one-way valve, but with a missing tip, i.e. the V-shaped pattern is tip free. The flow path comprises a generally hydrophilic surface area 31 with a hydrophobic pattern 32 in the form of a tip free V-shape. The selected pattern is thus arranged with a geometry partly across the flow path so that a flow path width section 33 (namely the missing tip) across the flow path at a distance of the border lines 34 of the flow path is free of the selected pattern.

If the liquid sample flows in the flow direction B, the flow will be completely or temporarily stopped by the tip free V-shaped hydrophobic pattern. Due to the surface energies of the various materials, the hydrophilic surface 31, the hydrophobic pattern 32, the liquid sample (which is often hydrophilic) and the air, the liquid flow front will be pinned near the missing tip (near the flow path width section 33) between the two legs of the V-shaped pattern, and thereby the flow will be stopped.

If the liquid sample flows in the flow direction A, the flow will simply enter through the gap in the tip free V-shaped pattern provided by the flow path width section 33 and gradually wet the hydrophobic pattern.

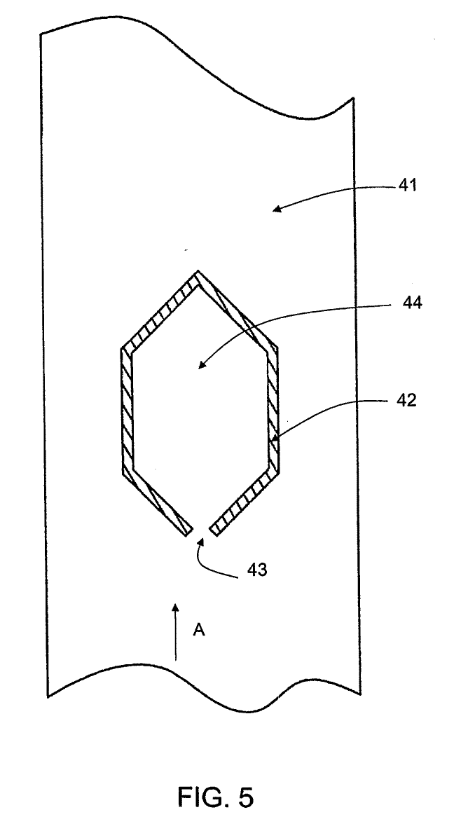

FIG. 5 shows a flow path with a hydrophobic pattern forming an island shaped segment. The flow path comprises a generally hydrophilic surface area 41 with a hydrophobic pattern 42 in the form of an island shaped segment formed by a surrounding flow blocking line 42. The central part of the island 44 may preferably have the surface layer of the higher surface tension e.g. similar surface tension as the generally hydrophilic surface area 41. The blocking line 42 comprises an opening 43 facing towards the inlet. The opening 43 is arranged as a one-way valve structure as disclosed above.

Such an island shaped segment is used for applying a reagent to the liquid sample. The reagent is applied onto the central part of the island 44, whereby the reagent is spread onto the central part of the island, but without passing the surrounding flow blocking line 42. Due to the one-way valve structure the reagent will not flow out of the central part of the island via the opening 43.

When a liquid sample is flowing along the flow path in the direction indicated with the arrow A, the liquid sample will pass via the opening 43 into the central part of the island, and gradually the liquid sample will wet the entire of the flow blocking line 42.

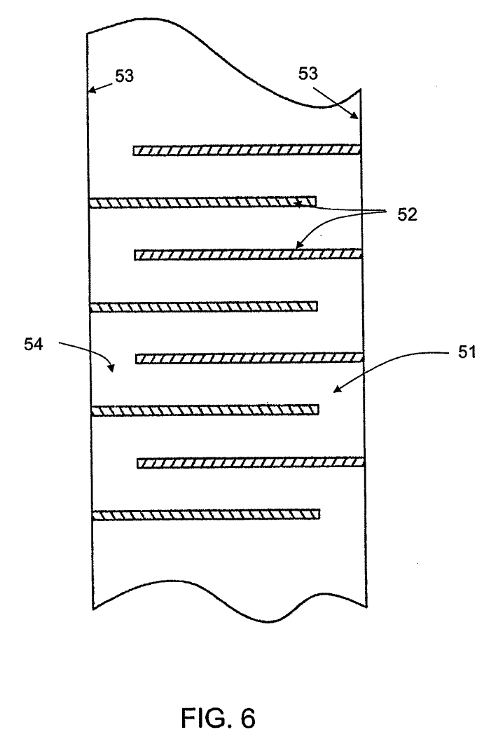

FIG. 6 shows a flow path with a hydrophobic pattern forming pairs of cross flow lines. The flow path comprises a generally hydrophilic surface area 51 with a hydrophobic pattern 52 in the form of a number of pairs of cross flow lines 52 extending from respective border lines 53 of the flow path and towards the respective opposite borderline 53 of the flow path. The pairs of cross flow lines 52 do not reach said opposite borderline but leave a gap 54 between the respective cross flow line and the opposite borderline. The pair of cross flow lines are placed with a distance d.

In use a liquid sample will be delayed by the pairs of cross flow lines 52. After the one or more pairs of cross flow lines have been wetted, they no longer constitute any delaying elements, and the liquid will simply flow over the hydrophobic pattern 52.

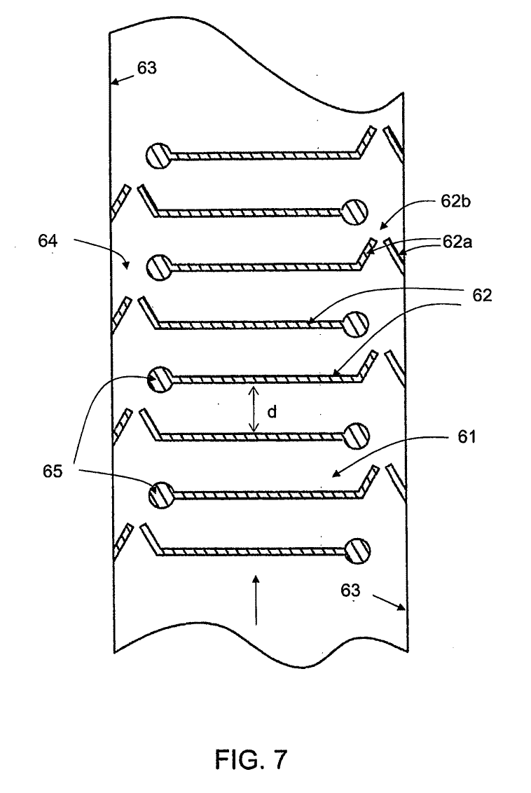

FIG. 7 shows a flow path with a hydrophobic pattern which is a variation of the hydrophobic pattern shown in FIG. 6.

The flow path comprises a generally hydrophilic surface area 61 with a hydrophobic pattern 62 in the form of a number of pairs of cross flow lines 62 extending from respective border lines 63 of the flow path and towards the respective opposite borderline 63 of the flow path. The pairs of cross flow lines 62 do not reach said opposite borderline but leave a gap 64 between the respective cross flow line and the opposite borderline. The pair of cross flow lines are placed with a distance d.

Each of the cross flow lines comprise a one-way valve 62 a in the form of a V-shaped free tip valve as shown in FIG. 4. The one-way valve 62 comprises a flow path width section 62b (namely the missing tip).

In the opposite ends of the one-way valve the cross flow lines comprise an increased section 65 shaped as a dot closest to the opposite borderline (the borderline it does not contact). Thereby the wetting process may be delayed as the liquid sample flows along the flow path.

The one-way vent is closed in the direction pointing towards the inlet, i.e. a flow in the liquid sample flow direction will be blocked until the one-way vent has been wetted from the other side of the cross flow line, when the liquid has passed onto said side. In this embodiment a slight mixing of the liquid sample will be performed.

In use a liquid sample will be delayed by the pairs of cross flow lines 62 and simultaneously a mixing will be performed. After the one or more pairs of cross flow lines have been wetted, they no longer constitute any delaying elements and the liquid will simply flow over the hydrophobic pattern 52.

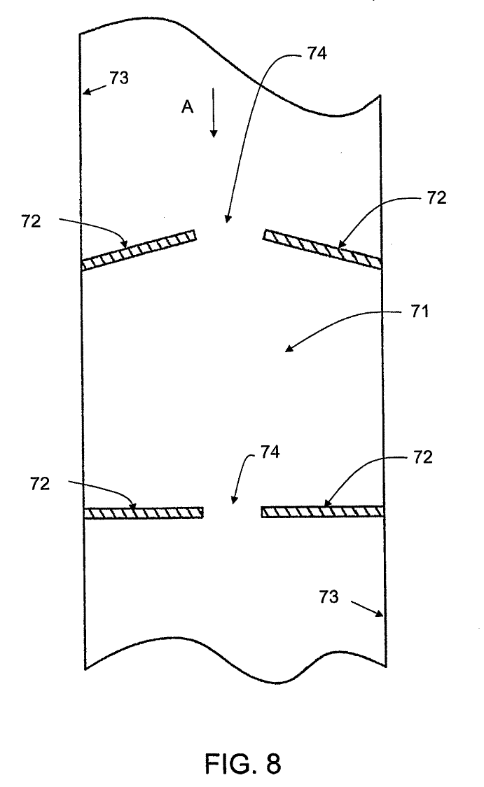

FIG. 8 shows a flow path with a hydrophobic pattern forming pairs of barrier lines. The flow path comprises a generally hydrophilic surface area 71 with a hydrophobic pattern 72 in the form of pair of barrier lines extending from respective borderlines 73 of the flow path and towards each other to provide a narrow opening 74 between the pair of barrier lines.

Often it will be desired to use such pairs of barrier lines 72 to delay all flow along the flow path.

In the shown embodiment the hydrophilic pattern comprises two pairs of barrier lines 72, one with essentially pair wise parallel barrier lines, and one with an angle between the barrier lines. In practice the flow path will normally be provided with a plurality of pairs of barrier lines to form a desired delay. In order to avoid “dead corners” or entrapping of bubbles it is often desired that the barrier line has at least a slight angle towards each other and extends from the respective borderlines towards each other in an angle so that the narrow opening faces the flow front as indicated with the flow direction arrow A.

The pair of barrier lines may also be used to guide the flow e.g. to straighten the flow.

In use a liquid sample will be delayed or stopped by the one or more pairs of barrier lines. If it is stopped an external force has to be applied for the liquid to pass the pair(s) of barrier lines. After the one or more pairs of barrier lines have been wetted, they no longer constitute any delaying or blocking elements, and the liquid will simply flow over the pair(s) of barrier lines as if they were not there at all.

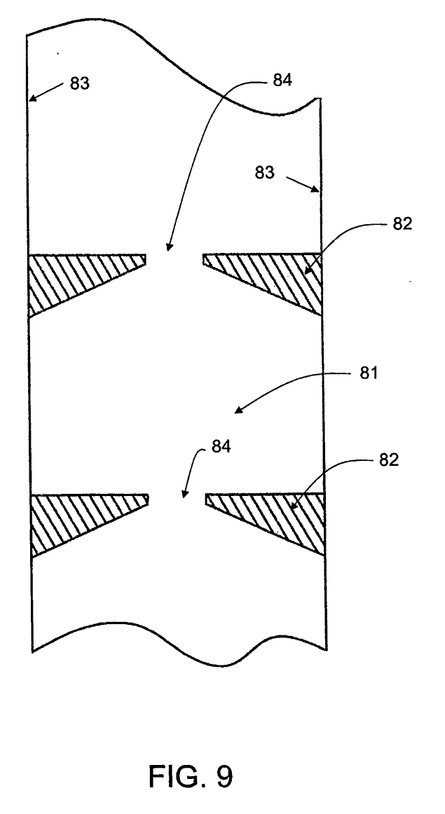

FIG. 9 shows a flow path with a hydrophobic pattern which is a variation of the pattern shown in FIG. 8.

The flow path comprises a generally hydrophilic surface area 81 with a hydrophobic pattern 82 in the form of pairs of barrier lines extending from respective borderlines 83 of the flow path and towards each other to provide a narrow opening 84 between the pair of barrier lines.

The barrier lines 82 are wedge shaped, which may result in an increased delaying effect compared to the pattern shown in FIG. 8, because the wedge shaped hydrophilic pattern may be more difficult to wet.

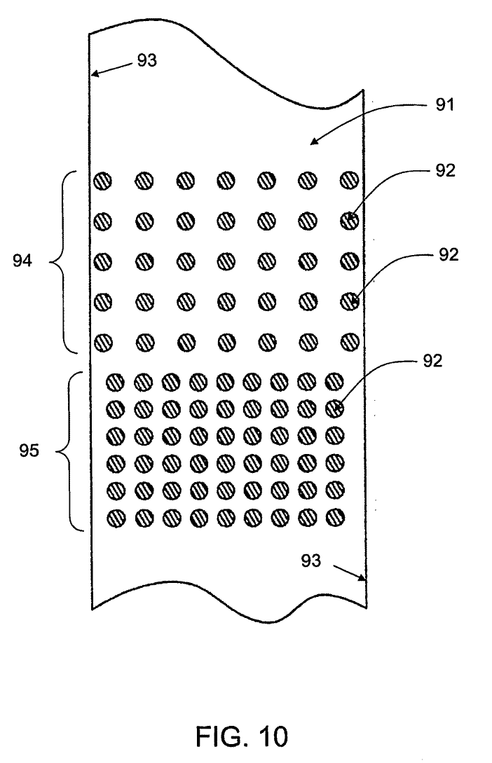

FIG. 10 shows a flow path with a hydrophobic pattern forming a plurality of microdots (a rastering design). The flow path comprises a generally hydrophilic surface area 91 with a hydrophobic pattern in the form of a plurality of microdots 92.

The microdots in the shown embodiments are arranged in two microdotted segments 94 and 95, wherein the microdots in the segment 95 are closer packed than the microdots in the segment 94. In the closer packed segment 95 the liquid sample will react as the surface is more hydrophobic than in the less closely packed segment 94. The microdots are periodically arranged in both segments 94 and 95.

By arranging the plurality of microdots e.g. in a periodic pattern over the flow path, different properties may be obtained, e.g. a delaying section may be provided. If the microdots are placed closer to each other than the depth of the flow path, an array of such microdots may completely block the capillary flow along the flow path.

As mentioned above the skilled person will understand that the microdots may be arranged in many other ways without deviate from the present invention.

1. A method of producing a microfluidic device having at least one flow path, said method comprising the steps of
i. providing a base substrate with a first surface and a top substrate with a second surface,
ii. hydrophilically treating at least one of the first and the second surfaces to provide a surface layer with a higher surface tension than the surface tension prior to the hydrophilic treatment,
iii. partly or totally removing the surface layer with a higher surface tension in a selected pattern of the hydrophilically treated first and/or second surfaces, to thereby provide the selected pattern with a lower surface tension than prior to the partly or totally removal of the surface layer with a higher surface tension in said selected pattern of the hydrophilic treated first and/or second surfaces, and
iv. joining said base substrate and top substrate to each other to provide a flow path between said first and second surfaces.

2. A method as claimed in claim 1 wherein said base substrate is a base cartridge comprising a base cavity, the first surface preferably comprises the surface of the base cavity and the hydrophilic treatment includes hydrophilic treatment of said first surface.

3. A method as claimed in claim 2, wherein the base cavity comprises a bottom surface and one or more edge surfaces, said base cavity forms at least one channel in said base cartridge.

4. A method as claimed in any one of the claims 2 and 3, wherein the said base cavity forms one or more channel sections, and one or more chambers in said base cartridge, said one or more channel sections and one or more chambers preferably being in fluid connection with each other.

5. A method as claimed in any one of the claims 2-4, wherein said base cavity comprises one or more edge portions with edge surfaces, said one or more edge portions comprise structural edge microstructures, preferably in the form of one or more of the structural shapes gaps, protrusions, and depressions, wherein the edge microstructures preferably being of substantial smaller dimension than the cavity of the base cartridge.

6. A method as claimed in any one of the preceding claims, wherein said top substrate is in the form of a lid, said second surface optionally being subjected to a hydrophilic treatment.

7. A method as claimed in any one of the preceding claims, wherein said step of joining said base substrate and top substrate to each other to provide a flow path between said first and second surfaces is performed so that the distance between said first and second surfaces along at least one flow path being of capillary dimension, preferably in the range 1 μm-1000 μm, such as 25 μm-250 μm, such as 50 μm-100 μm.

8. A method as claimed in any one of the preceding claims, wherein said flow path is in the form of a flow channel, having a bottom and edges formed by the first surface and a lid formed by the second surface.

9. A method as claimed in any one of the preceding claims, wherein one or more of said base substrates and said top substrate are made from a material selected from the group consisting of glass, ceramics, metals, silicon, polymers such as plastics, preferably at least said base substrate being of a polymer material, said base substrate preferably being shaped using injection moulding.

10. A method as claimed in claim 9 wherein said one or more of said base substrates and said top substrate are made from a polymer, preferably one or more of said base substrate and said top substrate being made from an injection mouldable polymer, such as a polymer selected from the group consisting of acrylonitrile-butadiene-styrene copolymer, polycarbonate, polydimethylsiloxane (PDMS), polyethylene, polymethylmethacrylate (PMMA), polymethylpentene, polypropylene, polystyrene, polysulfone, polytetrafluoroethylene (PTFE), polyurethane, polyvinylchloride (PVC), polyvinylidine fluoride, nylon, styrene-acryl copolymers and mixtures thereof.

11. A method as claimed in any one of the preceding claims, wherein at least one of said first and the second surfaces of the substrates have a surface tension prior to the hydrophilic treatment which is less than 80, preferably less than 73, such as less than 60, such as between 20 and 50 mN/m, preferably at least one of the first and the second surfaces of the substrates which is subjected to the hydrophilic treatment has an initial surface tension prior to the hydrophilic treatment which is less than 80, preferably less than 73, such as less than 60, such as between 20 and 50 mN/m.

12. A method as claimed in any one of the preceding claims, wherein the hydrophilic treatment provides at least one of the first and the second surfaces with a surface tension of more than 60, preferably of more than 70 mN/m, more preferably of more than 85 mN/m.

13. A method as claimed in any one of the preceding claims, wherein the hydrophilic treatment provides at least one of the first and the second surfaces with a surface tension which is increased with at least 5 mN/m, such as at least 10 mN/m, such as at least 15 mN/m, such as at least 20 mN/m, compared to its initial surface tension prior to the hydrophilic treatment.

14. A method as claimed in any one of the preceding claims, wherein the step of partly or totally removing the surface layer with a higher surface tension in a selected pattern of the hydrophilically treated first and/or second surfaces provides the pattern with a surface tension which is decreased with at least 3 mN/m, such as at least 5 mN/m, such as at least 10 mN/m, such as 30, at least 15 mN/m, such as at least 20 mN/m, compared to surface tension prior to the step of partly or totally removing the surface layer.

15. A method as claimed in any one of the preceding claims, wherein the step of partly or totally removing the surface layer with a higher surface tension in a selected pattern of the hydrophilically treated first and/or second surfaces provides the pattern with a surface tension which is less than 80, preferably less than 73, such as less than 60, such as between 20 and 50 mN/m.

16. A method as claimed in any one of the preceding claims, wherein the step of partly or totally removing the surface layer with a higher surface tension in a selected pattern of the hydrophilically treated first and/or second surfaces provides the pattern with a surface tension which is between 25 mN/m above and 10 mN/m below the surface tension of said surface prior to the hydrophilic treatment.

17. A method as claimed in any one of the preceding claims in combination with a selected liquid sample, wherein at least one of said first and the second surfaces of the substrates have a contact angle to the selected sample prior to the hydrophilic treatment which is more than 45 degrees, such as more than 50 degrees, such as more than 60 degrees, such as more than 70 degrees.

18. A method as claimed in any one of the preceding claims in combination with a selected liquid sample, wherein the hydrophilic treatment provides at least one of the first and the second surfaces with a contact angle to the selected sample of less than 45 degrees, preferably of less than 30 degrees, such as less than 20 degrees, such as less than 10 degrees, such as less than 5 degrees.

19. A method as claimed in any one of the preceding claims in combination with a selected liquid sample, wherein the step of partly or totally removing the surface layer with a higher surface tension in a selected pattern of the hydrophilically treated first and/or second surfaces provides the pattern with a contact angle to the selected sample which is more than 45 degrees, preferably more than 50 degrees, such as more than 60 degrees, such as more than 70 degrees, such as more than 75 degrees, such as more than 90 degrees.

20. A method as claimed in any one of the preceding claims, wherein the hydrophilic treatment is provided by coating the surface and/or chemically modifying the surface and/or physically modifying the surface.

21. A method as claimed in claim 20, wherein the hydrophilic treatment is provided by chemically modifying the surface, chemical modification preferably comprising treating the surface with one or more of the treatments selected from the group consisting of gas plasma treatment, corona discharge treatment, UV/ozone treatment, flame treatment, ion beam treatment e.g. using argon and/or oxygen and treatment with oxidizing chemicals, such as acids e.g. chromic acid.

22. A method as claimed in any one of the claims 20 and 21 wherein the hydrophilic treatment is provided by application of a coating, the coating may preferably be applied using one or more of the methods selected from the group consisting of plasma deposition, spraying, dipping, printing, vacuum deposition, chemical plating, painting, grafting, immobilization process, hydrogel encapsulation, and ion implantation process e.g. including bombardment with high-energy particles.

23. A method as claimed in any one of the claims 20-22 wherein the hydrophilic treatment includes coating with one or more of the compositions selected from the group consisting of cellulose polymers, polyacrylamide, polydimethylacrylamide, acrylamide-based copolymers, polyvinyl alcohol, polyvinylpyrrolidone, polyethylene oxide, Pluronic™ polymers or poly-N-hydroxyethylacrylamide, poly-imines, poly-oxazolines, Tween™ (polyoxy-ethylene derivative of sorbitan esters), silicon polymers (such as siloxanes e.g. pentasiloxane and polyether modified siloxanes) dextran, sugar, hydroxyethyl methacrylene, and indoleactic acid.

24. A method as claimed in any one of the claims 20-23 wherein the hydrophilic treatment includes coating using plasma deposition, optionally using one or more of the monomers selected from the group consisting of methacrylic acid anhydride, acrylic acid, methacrylic acid, acrylic acid anhydride, 4-pentenoic anhydride, acrolein, methacrolein, 1,2-epoxy-5-hexene, 1-vinyl-2-pyrrolidone, 1-vinyl-2-formamide, R-oxazolines (R being e.g. but not exclusively, methyl, ethyl), ethylene-glycol containing precursors like ethylene-glycol, diethylene-glycol, diethylene-glycol-di-vinylether, diglyme, triglyme, tetraglyme, crown ethers, such as 12-crown-4 ether, 15-crown-5 ether, glycidylmethacrylate, aceto-nitrile, acrylo-nitril, allylamine, allylmercaptane organosilicon compositions such as hexamethyldisiloxane and methoxytrimethylsilane; organophosphorous such as trimethylphosphite and trimethylphosphate; and organoborate such as trimethylborate and triethylborate.

25. A method as claimed in any one of the claims 20-24 wherein the hydrophilic treatment includes coating the surface, the thickness of the coating preferably being less than 1 μm, such as between 5 nm and 50 nm.

26. A method as claimed in any one of the preceding claims, wherein the hydrophilic treatment includes treating the entire of the first or second surfaces, preferably the hydrophilic treatment includes treating the entire of at least the first surface.

27. A method as claimed in any one of the preceding claims, wherein the step of partly or totally removing the surface layer with a higher surface tension is performed using a laser treatment, the laser treatment preferably being performed using a laser which is capable of providing an absorbed energy density at the surface sufficient to remove (e.g. ablate) at least a part of the surface layer having a higher surface tension.

28. A method as claimed in any one of the preceding claims 20 and 26-27, wherein the hydrophilic treatment is provided by physically modifying the surface by increasing the roughness of the surface, e.g. using laser treatment, the step of partly or totally removing the surface layer with a higher surface tension using a laser treatment, comprises the step of laser treating the surface to at least partly soften or even melt the surface to thereby decrease the roughness of the surface.

29. A method as claimed in any one of the claims 27 and 28 wherein the laser is a CO₂ laser or an UV laser, preferably an UV excimer laser, optionally a flow of an inert gas, such as helium being provided during the laser treatment.

30. A method as claimed in any one of the claims 27-29, wherein the laser treatment includes treating the surface in the desired pattern with an energy of between 100 and 10000 mJ/cm², such as between 200 and 2000 mJ/cm², such as between 250 and 1000 mJ/cm².

31. A method as claimed in any one of the claims 27-30, wherein the laser treatment being performed using a mask, the mask optionally corresponding to the desired pattern or the mask and substrate being moved relative to each other during the laser treatment to thereby provide the selected pattern.

32. A method as claimed in any one of the preceding claims, wherein the step of partly or totally removing the surface layer with a higher surface tension comprises removing a layer thickness in the selected pattern of 0.1 nm-10 μm, preferably between 0.1 nm-500 nm.

33. A method as claimed in any one of the preceding claims, wherein the selected pattern is a micropattern comprising one or more pattern segments with at least one dimension less than 250 preferably less than 200 μm, such as less than 150 μm, such as less than 100 μm, such as less than 50 μm, such as less than 25 μm, preferably less than 10 μm, such as less than 5 μm.

34. A method as claimed in claim 33 wherein the selected pattern is a micropattern comprising a plurality of microdots having dimensions up to 30 μm, such as up to 25 μm, such as up to 20 μm, such as up to 15, μm, such as between 1 and 20 μm, the major part (50% by number or more) of the microdots preferably has a shortest distance to the closest microdot which is 30 μm or less, such as up to 25 μm, such as up to 20 μm.

35. A method as claimed in claim 34, wherein the individual microdots have one or more of the shapes selected from round, oval or angular, such as triangular, square, rectangular, pentagonal and hexagonal, and other euclidic forms the individual microdots preferably being applied in a periodic pattern.

36. A method as claimed in any one of the preceding claims, wherein the selected pattern extends totally or partly across a flow path.

37. A method as claimed in claim 36, wherein the selected pattern comprises a pair of barrier lines extending from respective border lines of the flow path and towards each other, the distance between the pair of barrier lines preferably being less than the depth of the flow path, such as less than 50% of the depth of the flow path, more preferably the distance between the pair of barrier lines preferably being 50% or less of the width of the path between the borderlines from where the pair of barrier lines contact said borderlines, more preferably the distance between the pair of barrier lines preferably being less than 250 μm, such as less than 200 μm, such as less than 150 μm, such as less than 100 μm, such as less than 50 μm, such as less than 25 μm, preferably less than 10 μm, such as less than 5 μm.

38. A method as claimed in claim 37, wherein the selected pattern comprises a plurality of pairs of barrier lines, the barrier lines preferably being placed at a distance to each other along a flow path.

39. A method as claimed in any one of the claims 37 and 38, wherein the one or more pairs of barrier lines, pair wise are essentially parallel, the respective pairs of barrier lines preferably having an angle to the borderlines of the flow path which is between 80 and 100 degrees, more preferably about 90 degrees.

40. A method as claimed in any one of the claims 37 and 38, wherein the one or more pairs of barrier lines, pair wise have an angle to each other, the respective pairs of barrier lines preferably having an angle to the borderlines of the flow path which is between 45 and 135 degrees, such as between 55 and 80 or between 100 and 125 degrees.

41. A method as claimed in claim 36, wherein the selected pattern comprises one or more pairs of cross flow lines extending from respective border lines of the flow path and towards the respective opposite borderline of the flow path the pair of cross flow line is placed with a distance to each other along the flow path, the distance preferably being between 5 and 100% of the width of the path between the borderlines from where the in flow direction first of the cross flow lines contacts one of said borderlines.

42. A method as claimed in claim 41, wherein the selected pattern comprises a plurality of pairs of cross flow lines, the cross flow lines preferably being placed at a distance to each other along a flow path.

43. A method as claimed in any one of the preceding claims, wherein the selected pattern comprises an island shaped segment, the island shaped segment preferably being formed by a totally or partly surrounding flow blocking line, the central part of the island optionally having the surface layer of the higher surface tension.

44. A method as claimed in claim 43 wherein the blocking line at least extends across 50% or more, such as 75% or more, such as 90% or more of the flow path on the side of the island facing towards the flow front in use, preferably the blocking line at least extends across a sufficient part of the flow path on the side of the island facing towards the flow front in use, so that an optional opening is less than the depth of the flow path, the optional opening in the blocking line of the flow path on the side of the island facing towards the flow front in use, preferably being less than 100 preferably less than 50 μm, such as between 25 and 100 μm.

45. A method as claimed in claim 44 wherein the blocking line at least extends across 50% or more, such as 75% or more, such as 90% or more around the island, the optionally gap(s) provided in the surrounding blocking line preferably being each less than 100 μm, preferably less than 50 μm, such as between 25 and 100 μm.

46. A method as claimed in any one of the preceding claims, wherein the selected pattern forms a one-way valve, the selected pattern extends totally or partly across a flow path to provide a hydrophobic barrier, and is arranged with a geometry to provide a capillary stop in one flow direction.

47. A method as claimed in claim 46, wherein the selected pattern forms a one-way valve, the selected pattern is arranged with a geometry so that the forces needed to overcome the hydrophobic barrier from one side of the flow path is higher than the forces needed from the other side of the flow path.

48. A method as claimed in any one of the claims 46 and 47, wherein the selected pattern is arranged with a geometry totally across the flow path so that a width section across the flow path at a distance of the border lines of the flow path comprises a narrowing hydrophobic barrier segment than across the remaining part of the flow path.

49. A method as claimed in claim 48 wherein the selected pattern has a V-shaped front, preferably the open end of the V-shape is arranged to face a liquid flow front along the flow path.

50. A method as claimed in any one of the claims 48 and 49, wherein the selected pattern is formed as a belt with one or more narrowing hydrophobic barrier segment(s) provided by one or more V-shaped notch in one side of the belt shape.

51. A method as claimed in any one of the claims 48-50, wherein the V-shape has an angle between its legs which is less than 120 degrees, preferably less than 100 degrees, such as less than 90 degrees.

52. A method as claimed in any one of the claims 46 and 47, wherein the selected pattern is arranged with a geometry partly across the flow path so that a flow path width section across the flow path at a distance of the border lines of the flow path is free of the selected pattern, the flow path width section preferably having a width which is less than 100 μm, preferably less than 50 μm, such as between 25 and 100 μm.

53. A method as claimed in claim 52 wherein the selected pattern has a tip free V-shaped front, the pattern free flow path width section is provided between the legs of the V-shape instead of a tip, preferably the open end of the V-shape is arranged to face a liquid flow front along the flow path.

54. A method as claimed in any one of the claims 52 and 53, wherein the selected pattern is formed as an interrupted belt, the one or more interruption(s) is/are provided by the pattern free flow path width section(s) in the form of one or more tip free V-shaped intersect(s) through the belt shape.

55. A method as claimed in any one of the claims 52-54, wherein the tip free V-shape has an angle between its legs which is less than 120 degrees, preferably less than 100 degrees, such as less than 90 degrees.

56. A method as claimed in any one of the claims 46-55, wherein the selected pattern totally or partly across the flow path comprises a V-shaped pattern the V-shape optionally being tip-free, the V-shape being provided by barrier lines, having an equal or varying thickness, such as a thickness which is broader closer to a borderline of the flow path than closer to a middle line along the flow path at equal distances to its two borderline along the flow path.

57. A method as claimed in any one of the claims 46-56, wherein the capillary stop is a full stop or a temporary stop, the temporary stop preferably provides a capillary stop of at least 1 second, such as of at least 5 seconds, such as of at least 10 seconds, such as of at least 30 seconds, such as up to 1 minute, such as up to 5 minutes, such as up to 10 minutes.

58. A method as claimed in any one of the claims 46-57, wherein the selected pattern comprises two one-way valves placed in a flow path at a distance from each other, the distance between the two one-way valves forms an island shaped segment, the two one-way valves are arranged to provide capillary stops out of the island shaped segment in both directions of the flow path.

59. A method as claimed in any one of the claims 44, 45 and 58, further comprising the step of applying a reagent onto the island shaped segment, and optionally drying it, prior to the step of joining said base substrate and top substrate to each other.

60. A method as claimed in any one of the preceding claims, wherein the selected pattern forms one or more segmentation lines, segmenting a flow path into 2 or more flow path segments, the selected pattern preferably comprises a plurality of segmentation lines, and thereby a plurality of flow path segments.

61. A method as claimed in claim 60 wherein the respective flow path segments each has a width which is sufficiently low to provide a flow delay, the width preferably being less than 250 μm, preferably less than 200 μm, such as less than 150 μm, such as less than 100 μm, such as less than 50 μM, such as less than 25 such as less than 10 μm.

62. A method as claimed in any one of the claims 60 and 61 wherein the respective flow path segments have a width which is less than the height of the flow path between the first and the second surfaces.

63. A method as claimed in any one of the claims 60-62 wherein at least one of the first and second surfaces of the flow path in the respectively flow path segments has a surface tension above 75 mN/m, preferably above 85 mN/m.

64. A method as claimed in any one of the claims 60-62 in combination with a selected sample wherein at least one of the first and second surfaces of the flow path in the respectively flow path segments has a contact angle to said sample which is less than 5 degrees, preferably about 0 degrees.

65. A method as claimed in any one of the preceding claims, wherein the selected pattern forms a full stop hydrophobic barrier extending totally across the flow path, the full stop hydrophobic barrier preferably being placed adjacent to the exit of the flow path.

66. A method as claimed in any one of the preceding claims, the method further comprises the step of hydrophobically treating at least one of the first and the second surfaces to provide a surface layer with a lower surface tension than the surface tension prior to the hydrophobic treatment.

67. A method as claimed in claim 66 wherein the step of hydrophobically treating at least one of the first and the second surfaces is performed prior to the step of hydrophilically treating at least one of the first and the second surfaces, the surface(s) subjected to the hydrophobic treatment preferably also being subjected to the hydrophilic treatment.

68. A method as claimed in any one of the claims 66 and 67, wherein at least one of said first and the second surfaces of the substrates have a surface tension prior to the hydrophobic treatment which is above 30, preferably above 35 mN/m, such as between 37 and 80 mN/m, preferably the hydrophobic treatment is performed directly onto the bulk material of the substrate.

69. A method as claimed in any one of the claims 66-68, wherein the hydrophobic treatment provides at least one of the first and the second surfaces with a surface tension of less than 50, preferably of less than 40, such as less than 30, such as less than 20 mN/m.

70. A method as claimed in any one of the claims 66-69, wherein the hydrophobic treatment provides at least one of the first and the second surfaces with a surface tension which is decreased with at least 5 mN/m, such as at least 10 mN/m, such as at least 15 mN/m, such as at least 20 mN/m, compared to its initial surface tension prior to the hydrophobic treatment.

71. A method as claimed in any one of the claims 66-70, wherein the step of partly or totally removing the surface layer with a higher surface tension in a selected pattern of the hydrophilically treated first and/or second surfaces exposes the hydrophobic layer provided by the hydrophobic treatment in at least a part of the selected pattern.

72. A method as claimed in any one of the claims 66-71, wherein the step of partly or totally removing the surface layer with a higher surface tension in a selected pattern of the hydrophilically treated first and/or second surfaces, also includes partly or totally removing the layer provided by the hydrophobic treatment in the selected pattern.

73. A method as claimed in any one of the claims 66-72, wherein the step of partly or totally removing the surface layer with a higher surface tension in a selected pattern of the hydrophilically treated first and/or second surfaces provides the selected pattern with a surface tension which is less than the surface tension of the bulk material of the substrate, preferably the selected pattern has two or more pattern sections which have surface tension different from each other.

74. A method as claimed in any one of the claims 66-73, wherein the hydrophobic treatment is provided by coating the surface and/or chemically modifying the surface.

75. A method as claimed in claim 74 wherein the hydrophobic treatment is provided by application of a coating, the coating may preferably be applied using one or more of the methods selected from the group consisting of plasma deposition, spraying, dipping, printing, vacuum deposition, chemical plating, grafting and immobilization process, hydrogel encapsulation.

76. A method as claimed in any one of the claims 74-75 wherein the hydrophobic treatment includes coating using plasma deposition, optionally using one or more of the monomers selected from the group consisting of acid halogenides, such as acrylic acid chloride and methacrylic acid chloride, fluorocarbons such as perfluoroalkanes, perfluoroalkenes such as tetrafluoroethylene and hexafluoropropene, perfluorocycloalkanes; hydrocarbons such as alkanes and alkenes such as ethylene, acetylene, propene, 1-hexene; partly substituted hydrocarbons like C₂F₂H₂; or 1,2-epoxy-3-phenoxypropane.

77. A method as claimed in any one of the claims 74-76 wherein the hydrophobic treatment includes coating the surface, the thickness of the coating preferably being up to 1 μm, such as between 25 nm and 500 nm

78. A method of producing a microfluidic device having at least one flow path, said method comprising the steps of
i. providing a base substrate with a first surface and a top substrate with a second surface,
ii. hydrophobically treating at least one of the first and the second surfaces to provide a surface layer with a lower surface tension than the surface tension prior to the hydrophobic treatment,
iii. partly or totally removing the surface layer with a lower surface tension in a selected pattern of the hydrophobically treated first and/or second surfaces, to thereby provide the selected pattern with a higher surface tension than prior to the partly or totally removal of the surface layer with a lower surface tension in said selected pattern of the hydrophobically treated first and/or second surfaces, and
iv. joining said base substrate and top substrate to each other to provide a flow path between said first and second surfaces.

79. A method as claimed in claim 78 wherein the selected pattern with a higher surface tension on at least one of the first and second surfaces of the flow path has a shape along the flow path arranged to provide the flow path with a sufficient hydrophilic character to provide a flow along the flow path.

80. A microfluidic device obtainable according to the method as defined in any one of the claims 1-79.

81. A microfluidic device in combination with a liquid sample, the microfluidic device being obtainable according to the method as defined in any one of the claims 1-79.

82. A microfluidic device according to any one of the claims 80 and 81 wherein the selected pattern preferably has a roughness which is higher than the roughness of the surrounding surface.

83. A microfluidic device as claimed in any one of the claims 80-82 wherein the selected pattern is a micro pattern having at least one dimension which is less than 250 μm, preferably less than 200 μm, such as less than 150 μm, such as less than 100 μm, such as less than 50 μm, such as less than 25 μm, preferably less than 10 μm, such as less than 5 μm.

84. A microfluidic device having at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a micropattern in the hydrophilic surface area, the micropattern comprising one or more pattern segments with at least one dimension less than 250 μm, preferably less than 200 μm, such as less than 150 μm, such as less than 100 μm, such as less than 50 μm, such as less than 25 μm, preferably less than 10 μm, such as less than 5 μm.

85. A microfluidic device as claimed in claim 84, wherein the micropattern comprises a plurality of microdots having dimensions up to 30 μm, such as up to 25 μm, such as up to 20 μm, such as up to 15, μm, such as between 1 and 20 μm, the major part (50% by number or more) of the microdots preferably has a shortest distance to the closest microdot which is 30 μm or less, such as up to 25 μm, such as up to 20 μm, the micropattern may e.g. form a full stop hydrophobic microdotted barrier extending totally across the flow path, the full stop hydrophobic microdotted barrier preferably being placed adjacent to the exit of the flow path.

86. A microfluidic device as claimed in claim 85, wherein the individual microdots have one or more of the shapes selected from round, oval or angular, such as triangular, square, rectangular, pentagonal and hexagonal, the individual microdots preferably being applied in a periodic pattern.

87. A microfluidic device as claimed in claim 84, wherein the micropattern comprises one or more lines preferably having a width of less than 100 μm, such as less than 50 μm, such as less than 25 μm, preferably less than 10 μm, such as less than 5 μm, the one or more lines preferably extend totally or partly across the flow path.

88. A microfluidic device optionally according to claim 87 and having at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a pattern in the hydrophilic surface area, the pattern comprises a pair of barrier lines extending from the respective border lines of the flow path and towards each other, the distance between the pair of barrier lines preferably being less than the depth of the flow path, such as less than 50% of the depth of the flow path, more preferably the distance between the pair of barrier lines preferably being 50% or less of the width of the path between the borderlines from where the pair of barrier lines contacts said borderlines, more preferably the distance between the pair of barrier lines preferably being less than 250 μm, such as less than 200 μm, such as less than 150 μm, such as less than 100 μm, such as less than 50 μm, such as less than 25 μm, preferably less than 10 μm, such as less than 5 μm.

89. A microfluidic device as claimed in claim 87 wherein the pattern comprises a plurality of pairs of barrier lines, the barrier lines preferably being placed at a distance to each other along a flow path

90. A microfluidic device as claimed in any one of the claims 87 and 88, wherein the one or more pairs of barrier lines, pair wise are essentially parallel, the respective pairs of barrier lines preferably having an angle to the borderlines of the flow path which is between 80 and 100 degrees, more preferably about 90 degrees.

91. A microfluidic device as claimed in any one of the claims 87 and 88, wherein the one or more pairs of barrier lines, pair wise have an angle to each other, the respective pairs of barrier lines preferably having an angle to the borderlines of the flow path which is between 45 and 135 degrees, such as between 55 and 80 or between 100 and 125 degrees.

92. A microfluidic device optionally according to claim 87 and having at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a pattern in the hydrophilic surface area, the pattern comprises an island shaped segment, the island shaped segment preferably being formed by a totally or partly surrounding flow blocking line, the central part of the island shaped segment, optionally having the surface layer of the higher surface tension, optionally the device comprises a reagent applied onto the central part of the island shaped segment.

93. A microfluidic device as claimed in claim 92 wherein the blocking line at least extends across 50% or more, such as 75% or more, such as 90% or more of the flow path on the side of the island facing towards the flow front in use, preferably the blocking line at least extends across a sufficient part of the flow path on the side of the island facing towards the flow front in use, so that an optional opening is less than the depth of the flow path, the optional opening in the blocking line of the flow path on the side of the island facing towards the flow front in use, preferably being less than 100 μm, preferably less than 50 μm, such as between 25 and 100 μm.

94. A microfluidic device as claimed in claim 93, wherein the blocking line at least extends across 50% or more, such as 75% or more, such as 90% or more around the island, the optionally gap(s) provided in the surrounding blocking line preferably being each less than 100 μm, preferably less than 50 μm, such as between 25 and 100 μm.

95. A microfluidic device optionally according to claim 87 and having at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a pattern in the hydrophilic surface area, the pattern comprises one or more pairs of cross flow lines extending from respective border lines of the flow path and towards the respective opposite borderline of the flow path, optionally one or more of the flow lines comprises a one-way valve.

96. A microfluidic device as claimed in claim 95 wherein the pair of cross flow lines are placed with a distance to each other along the flow path, the distance preferably being between 5 and 100% of the width of the path between the borderlines from where the in flow direction first of the cross flow lines contacts one of said borderlines.

97. A microfluidic device as claimed in any one of the claims 95 and 96 wherein the pattern comprises a plurality of pairs of cross flow lines, the cross flow lines preferably being placed at a distance to each other along a flow path.

98. A microfluidic device as claimed in any one of the claims 95-97 wherein one or more of the flow lines comprise a one-way valve, the one-way valve being provided by the hydrophobic pattern.

99. A microfluidic device optionally according to any one of the claims 87 and 95-98, and having at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a pattern in the hydrophilic surface area, the pattern forms a one-way valve, the selected pattern extends totally or partly across a flow path to provide a hydrophobic barrier, and is arranged with a geometry to provide a capillary stop in one flow direction.

100. A microfluidic device as claimed in claim 99, wherein the pattern forms a one-way valve, the selected pattern is arranged with a geometry so that the forces needed to overcome the hydrophobic barrier from one side of the flow path are higher than the forces needed from the other side of the flow path.

101. A microfluidic device as claimed in any one of the claims 99 and 100, wherein the pattern is arranged with a geometry totally across the flow path so that a width section across the flow path at a distance of the border lines of the flow path comprises a narrowing hydrophobic barrier segment than across the remaining part of the flow path.

102. A microfluidic device as claimed in claim 101 wherein the pattern has a V-shaped front, preferably the open end of the V-shape is arranged to face a liquid flow front along the flow path.

103. A microfluidic device as claimed in any one of the claims 101 and 102, wherein the pattern is formed as a belt with one or more narrowing hydrophobic barrier segment(s) provided by one or more V-shaped notch in one side of the belt shape.

104. A microfluidic device as claimed in any one of the claims 101-103, wherein the V-shape has an angle between its legs which is less than 120 degrees, preferably less than 100 degrees, such as less than 90 degrees.

105. A microfluidic device as claimed in any one of the claims 99-100, wherein the pattern is arranged with a geometry partly across the flow path so that a flow path width section across the flow path at a distance of the border lines of the flow path is free of the selected pattern, the flow path width section preferably having a width which is less than 100 μm, preferably less than 50 μm, such as between 25 and 100 μm.

106. A microfluidic device as claimed in claim 105, wherein the pattern has a tip free V-shaped front, the pattern free flow path width section is provided between the legs of the V-shape instead of a tip, preferably the open end of the V-shape is arranged to face a liquid flow front along the flow path.

107. A microfluidic device as claimed in any one of the claims 105 and 106, wherein the pattern is formed as an interrupted belt, the one or more interruption(s) is/are provided by the pattern free flow path width section(s) in the form of one or more tip free V-shaped intersect(s) through the belt shape.

108. A microfluidic device as claimed in any one of the claims 105-107, wherein the tip free V-shape has an angle between its legs which is less than 120 degrees, preferably less than 100 degrees, such as less than 90 degrees.

109. A microfluidic device as claimed in any one of the claims 105-108, wherein the pattern totally or partly across the flow path comprises a V-shaped pattern the V-shape optionally being tip-free, the V-shape being provided by barrier lines, having an equal or varying thickness, such as a thickness which is broader closer to a borderline of the flow path than closer to a middle line along the flow path at equal distances to its two borderline along the flow path.

110. A microfluidic device as claimed in any one of the claims 99-109, wherein the capillary stop is a full stop or a temporary stop, the temporary stop preferably provides a capillary stop of at least 1 second, such as of at least 5 seconds, such as of at least 10 seconds, such as of at least 30 seconds, such as up to 1 minute, such as up to 5 minutes, such as up to 10 minutes.

111. A microfluidic device as claimed in any one of the claims 99-110, wherein the pattern comprises two one-way valves placed in a flow path at a distance from each other, the distance between the two one-way valves forms an island shaped segment, the two one-way valves are arranged to provide capillary stops out of the island shaped segment in both directions of the flow path.

112. A microfluidic device as claimed in any one of the claims 99-111, wherein the pattern comprises one or more pairs of cross flow lines extending from respective border lines of the flow path and towards the respective opposite borderline of the flow path, at least one of the flow lines comprises a one-way valve, the one-way valve being arranged so that a liquid sample flowing along the flow path in one flow direction cannot pass the one-way valve from one side until the liquid sample has wetted the surface of the flow path on the other side of the one-way valve.

113. A microfluidic device optionally according to claim 87, and having at least one flow path and comprising a base substrate with a first surface and a top substrate with a second surface, the first and the second surfaces face each other, the at least one flow path being provided between said first and second surfaces, at least one of said surfaces comprising a hydrophilic surface area and a hydrophobic surface area, wherein the hydrophobic surface area has a lower surface tension than the hydrophilic surface area, the hydrophobic surface area forms a micropattern in the hydrophilic surface area, the pattern forms one or more segmentation lines, segmenting a flow path into 2 or more flow path segments, the selected pattern preferably comprises a plurality of segmentation lines, and thereby a plurality of flow path segments.

114. A microfluidic device as claimed in claim 113 wherein the respective flow path segments have a cross width which is sufficiently low to provide a flow delay, the width preferably being less than 25 μm, such as less than 10 μm.

115. A microfluidic device as claimed in any one of the claims 113 and 114 wherein the respective flow path segments have a cross width which is less than the height of the flow path between the first and the second substrates.

116. A microfluidic device as claimed in any one of the claims 113-115, wherein at least one of the first and second surfaces of the flow path in the respectively flow path segments has a surface tension above 75 mN/m, preferably above 85 mN/m.

117. A microfluidic device as claimed in any one of the claims 113-116, in combination with a selected sample wherein at least one of the first and second surfaces of the flow path in the respective flow path segments have a contact angle to said sample which is less than 5 degrees, preferably about 0 degrees.

118. A microfluidic device as claimed in any one of the claims 84-117 wherein said base substrate comprises a base cavity, the base cavity comprises a bottom surface and one or more edge surfaces, said base cavity forms at least one channel in said base substrate, the first surface preferably comprises the bottom surface of the base cavity.

119. A microfluidic device as claimed in any one of the claims 84-118 wherein the hydrophobic surface area has a surface tension which is less than 80, preferably less than 73, such as less than 60, such as between 20 and 50 mN/m, preferably at least one of the first and the second surfaces of the substrates which is subjected to the hydrophilic treatment has an initial surface tension prior to the hydrophilic treatment which is less than 80, preferably less than 73, such as less than 60, such as between 20 and 50 mN/m.

120. A microfluidic device as claimed in any one of the claims 84-119 wherein the hydrophilic surface area has a surface tension which is more than 60 mN/m, preferably of more than 70 mN/m, such as more than 85 mN/m.

121. A microfluidic device as claimed in any one of the claims 84-120, wherein one of said first and second surfaces comprises a hydrophilic surface area and a hydrophobic surface area, the other one of said first and second surfaces designated the homogeneous surface has equal surface tension on its entire surface, the surface tension of the homogeneous surface preferably being more than 60 mN/m, preferably of more than 70 mN/m.

122. A microfluidic device as claimed in any one of the claims 84-121 in combination with a selected liquid sample, wherein said hydrophilic surface area has a contact angle to the selected sample of less than 45 degrees, preferably of less than 30 degrees, such as less than 20 degrees, such as less than 10 degrees, such as less than 5 degrees.

123. A microfluidic device as claimed in any one of the claims 84-122 in combination with a selected liquid sample, wherein said hydrophobic surface area has a contact angle to the selected sample which is more than 45 degrees, preferably more than 50 degrees, such as more than 60 degrees, such as more than 70 degrees, such as more than 75 degrees, such as more than 90 degrees.
